(19) United States
(12) Patent Application Publication
(10) Pub. No.: US 2026/0196516 A1
(43) Pub. Date: Jul. 9, 2026

(54) SECONDARY BATTERY, MANUFACTURING METHOD THEREOF, AND VEHICLE

(71) Applicant: SEMICONDUCTOR ENERGY LABORATORY CO., LTD., Atsugi-shi, Kanagawa-ken (JP)

(72) Inventors: Yusuke YOSHITANI, Isehara, Kanagawa (JP); Teppei OGUNI, Atsugi, Kanagawa (JP); Noriko MIYAIRI, Hadano, Kanagawa (JP); Tetsuji ISHITANI, Atsugi, Kanagawa (JP); Takashi HIRAHARA, Isehara, Kanagawa (JP)

(21) Appl. No.: 18/863,783

(22) PCT Filed: May 8, 2023
(86) PCT No.: PCT/IB2023/054741

§ 371 Date: Nov. 7, 2024

(30) Foreign Application Priority Data
May 13, 2022 (JP) 2022-079392

(51) Int. Cl. H01M 4/62; H01M 4/02

(52) U.S. Cl. CPC H01M 4/624; H01M 2004/021; H01M 2004/028

(57) ABSTRACT

One embodiment of the present invention provides a highly safe or reliable secondary battery. The secondary battery includes a positive electrode, a negative electrode, and an electrolyte. The positive electrode includes a positive electrode active material layer containing nickel, cobalt, and manganese. The positive electrode active material layer includes a secondary particle. The secondary particle includes a plurality of primary particles. A layer containing calcium is present between adjacent two of the plurality of primary particles. The thickness of the layer containing calcium is greater than or equal to 1 nm and less than or equal to 10 nm. The density of the layer containing calcium is higher than or equal to 2.0 g/cm³ and lower than 3.3 g/cm³.

### TECHNICAL FIELD

One embodiment of the present invention relates to a positive electrode active material, a secondary battery, and a manufacturing method thereof. One embodiment of the present invention relates to a portable information terminal and a vehicle each including a secondary battery.

One embodiment of the present invention relates to an object or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that semiconductor devices in this specification mean all devices that can function by utilizing semiconductor characteristics, and an electro-optical device, a semiconductor circuit, and an electronic device are all semiconductor devices.

Note that in this specification, a power storage device refers to all elements and devices having a function of storing power. For example, a power storage device (also referred to as a secondary battery) such as a lithium-ion secondary battery, a lithium-ion capacitor, and an electric double layer capacitor are included.

### BACKGROUND ART

In recent years, lithium-ion secondary batteries, lithium-ion capacitors, air batteries, or a variety of power storage devices have been actively developed. In particular, demand for lithium-ion secondary batteries with high output and high energy density has rapidly grown with the development of portable information terminals typified by mobile phones, smartphones, or laptop computers, portable music players, digital cameras, medical equipment, next-generation clean energy vehicles typified by hybrid electric vehicles (HVs), electric vehicles (EVs), or plug-in hybrid electric vehicles (PHVs), and the semiconductor industry, and the lithium-ion secondary batteries are essential for today's information society as rechargeable energy supply sources.

Patent Document 1 discloses a positive electrode active material containing calcium for a lithium-ion secondary battery.

### REFERENCE

### Patent Document

### Patent Document 1]

Japanese Published Patent Application No. 2022-045353

### SUMMARY OF THE INVENTION

### Problems to be Solved by the Invention

An object of one embodiment of the present invention is to provide a positive electrode active material that is less likely to deteriorate. Another object is to provide a novel positive electrode active material. Another object is to provide a highly safe or highly reliable secondary battery. Another object is to provide a secondary battery that is less likely to deteriorate. Another object is to provide a long-life secondary battery. Another object is to provide a novel secondary battery.

Note that the description of these objects does not preclude the existence of other objects. One embodiment of the present invention does not need to achieve all of these objects. Other objects can be derived from the description of the specification, the drawings, and the claims.

### Means for Solving the Problems

For a lithium-ion secondary battery, what is called NCM represented by LiNi_{X}Co_{Y}Mn_{Z}O₂ (X+Y+Z=1) is generally used. A material containing transition metals at approximately the same ratios, like Ni: Co: Mn=1:1:1, contains a large amount of cobalt, which is a noble metal, and thus is likely to result in a high cost. There is an attempt to increase the capacity of batteries by reducing the use amount of cobalt and increasing the use amount of nickel.

NCM with a large use amount of nickel has a problem in that oxygen is easily released and deterioration is likely to occur. Furthermore, there is also a problem in that a phenomenon called cation mixing in which a transition metal typified by nickel or manganese enters a site for lithium ions to be occluded or released in charging and discharging is likely to occur.

In NCM, a plurality of primary particles are aggregated to form a secondary particle. By charging or discharging, occlusion or release of lithium ions occurs and the primary particle expands or contracts. The expansion or contraction of the primary particle causes volume change and disaggregation of the primary particles, making the secondary particle have a crack or become finer. One of the factors that make the secondary particle have a crack or become finer is a change in the a-axis or the c-axis of a crystal of NCM due to repetitive charging or discharging, which increases the gap between the primary particles. Note that “the gap between the primary particles” is not used to mean a space, and in the case of a secondary battery, an electrolyte solution is present in the position of the gap. However, in the case of an all-solid-state battery, the gap literally means a gap.

In a positive electrode used for a secondary battery, a positive electrode active material layer where an NCM powder and a conductive additive are mixed and bonded with a binding agent is formed on a current collector. When a volume change occurs in charging and discharging of the secondary battery and accordingly the number of cracks generated between primary particles or the number of fine particles is increased, the secondary battery is degraded in lifetime characteristics and increased in resistance. When the secondary particle of NCM has a crack or becomes finer, the positive electrode has a larger number of portions where electron conduction is not ensured and the secondary battery has higher internal resistance, so that the lifetime characteristics of the secondary battery are degraded.

In view of this, in order to achieve at least one of the above objects, a thin layer containing calcium is provided between two adjacent primary particles, thereby inhibiting generation of cracks between the primary particles in charging and discharging and improving the lifetime characteristics of the secondary battery. The thickness of the thin layer containing calcium is less than 10 nm.

The thin layer containing calcium is an amorphous layer. An amorphous layer has a lower density than a crystal and includes a gap (free volume), and thus experiences structural relaxation. The thin layer containing calcium preferably further contains aluminum. The layer containing calcium may further contain silicon. The layer containing calcium may further contain sulfur.

Furthermore, a calcium compound may be attached to at least part of the outer surface of the secondary particle. Note that the three-dimensional shape of the secondary particle is spherical or substantially spherical, and the calcium compound is attached to the secondary particle so as to cover part of the outermost surface. The calcium compound has a size greater than or equal to 1 μm and less than or equal to 10 μm. The calcium compound may have a crystal structure or an amorphous structure. A region of the outer surface of the secondary particle where the calcium compound is attached fixes primary particles and protects a region that is not in contact with an electrolyte solution in a manufactured secondary battery. In the case where the calcium compound is formed on the entire surface of the secondary particle, lithium ion transfer might be inhibited in charging and discharging; thus, the calcium compound preferably does not cover the entire surface of the secondary particle.

A secondary particle is an aggregation of a plurality of primary particles, and the secondary particle includes a gap between the primary particles. The primary particle includes a polycrystal or a single crystal. In a manufactured secondary battery, an electrolyte solution is in contact with not only the outer surface of the secondary particle formed of aggregated primary particles but also the gap or a portion where the primary particles are bonded incompletely inside the secondary particle. This accordingly enables insertion and extraction of lithium in the regions in contact with the electrolyte solution and brings an advantage of improving the capacity characteristics. On the other hand, if the regions in contact with the electrolyte solution are unstable, there might be a disadvantage in that deterioration is promoted in the portions, that is, the cycle performance is degraded.

Even between the plurality of primary particles that are in close contact with each other, bonding between the primary particles is incomplete and permeation of the electrolyte solution is allowed in some cases. In that case, a contact between the electrolyte solution and the portion where the primary particles are bonded incompletely might promote deterioration. The contact between the electrolyte solution and the portion where the primary particles are bonded incompletely might form a coating film between the primary particles and increase the distance between the primary particles.

The thin layer containing calcium (the amorphous layer) and provided between adjacent two primary particles can prevent the contact between the electrolyte solution and the portion where the primary particles are bonded incompletely, thereby preventing an increase in distance between the primary particles. Note that the thin layer containing calcium (the amorphous layer) is not a coating film formed on the surface of the primary particle due to the contact with the electrolyte solution, but is already formed before the primary particle is in contact with the electrolyte solution.

The structure disclosed in this specification is a secondary battery including a positive electrode, a negative electrode, and an electrolyte. The positive electrode includes a positive electrode active material layer containing nickel, cobalt, and manganese. The positive electrode active material layer includes a secondary particle. The secondary particle includes a plurality of primary particles. A layer containing calcium is present between adjacent two of the plurality of primary particles. The thickness of the layer containing calcium is greater than or equal to 1 nm and less than or equal to 10 nm.

In the above structure, the layer containing calcium is amorphous.

When the primary particle or the secondary particle obtained by a coprecipitation method is mixed with lithium hydroxide, the primary particle or the secondary particle is partly broken by collision, so that exposed surfaces are formed. After the mixing with the lithium hydroxide, calcium or aluminum is further added and then mixing and heating are performed again, whereby calcium or aluminum is attached to the exposed surfaces to fix the two exposed surfaces of particles, or calcium or aluminum is diffused to the interface between the fixed surfaces and placed as a thin layer like an adhesive. The thin layer is amorphous. The thin amorphous layer has a lower density than the inner portion of the primary particle and allows diffusion of lithium ions, and has a bonding function and a function of a path through which lithium ions pass.

Thus, the amorphous layer can fix two primary particles like an adhesive to make them function as one large particle without a crack. Lithium ions can be diffused through the amorphous layer to be occluded by or released from the particle efficiently.

When heat treatment is performed after the addition of calcium and aluminum, calcium and aluminum are sometimes diffused to an interface where surfaces of two primary particles are in close contact with each other (a space between the two primary particles) to form a thin layer at the interface (also referred to as a grain boundary) of the two primary particles.

Calcium has a large atomic radius and subsequent heat treatment is performed at a temperature lower than that at which the primary particle is melted; thus, it is difficult to diffuse calcium into the primary particle, i.e., to the inner portion and the surface portion of the primary particle. Accordingly, although calcium is contained in the amorphous layer, it is difficult to detect calcium in the primary particle in contact with the amorphous layer. In contrast, aluminum is diffused easily and present also in the amorphous layer, the inner portion of the primary particle, and the surface portion of the primary particle; in particular, the aluminum concentration is higher in the surface portion of the primary particle than in the other regions. Thus, the primary particle can be regarded as a positive electrode active material particle in which the surface portion is NCMA and the inner portion is NCM.

In addition, when a crack (crevice) is generated before the addition of calcium for some reason such as mixing treatment, the crack is likely to be generated between regions with different crystal planes, and a slight gap might be generated. By the addition of calcium or the addition of aluminum, calcium or aluminum is diffused to the slight gap of the crack to form the thin layer containing calcium (the amorphous layer) in some cases. When the crack develops, part of the particle might be separated with the crack plane as a boundary and become a fine particle. Formation of the thin layer containing calcium (the amorphous layer) can inhibit the development of the crack.

The amorphous layer is considered to have a lower density and higher resistance to deformation than the inner portion of the primary particle (polycrystal or single crystal), and thus can flexibly respond to a physical change even when expansion and contraction are caused by charging and discharging.

When the electrolyte solution is in direct contact with the crack plane of the primary particle, a side reaction might occur. In addition, charging and discharging cause a chemical reaction and a thin coating film (an oxide film or a decomposition product of the electrolyte solution) is formed in some cases. The thin film formed by the electrolyte solution brings advantage and disadvantage for the secondary battery. Specifically, the thin coating film has the advantage of preventing a crack or excessive decomposition of the electrolyte solution and the disadvantage of possibly being a factor of capacity reduction or deterioration.

The amorphous layer is a layer formed before the contact with the electrolyte solution used in manufacturing the secondary battery, and is formed at the stage of forming the positive electrode active material layer on the positive electrode current collector. The amorphous layer is not a coating film formed by the contact with the electrolyte solution. The amorphous layer formed before the contact with the electrolyte solution can also prevent formation of a coating film derived from the electrolyte solution.

When the positive electrode active material layer is formed on the current collector, pressing may be performed after a plurality of secondary particles are mixed with a conductive additive or a binding agent; even when external pressure is applied by the pressing, two particles connected by the thin layer containing calcium (the amorphous layer) are less likely to be cracked. In addition, when the thin layer containing calcium (the amorphous layer) is provided in the cracked portion, one particle is less likely to be cracked even when external pressure is applied by the pressing.

Note that the secondary particle is an aggregation of at least two primary particles, and the number of primary particles forming the secondary particle may vary, for example, may be two, three, or four or more. Accordingly, one secondary particle is sometimes referred to as a group of aggregations with different numbers of primary particles. When formed of a small number of primary particles, the secondary particle has a relatively small surface area, and accordingly reaction with the electrolyte solution occurs in a small region.

There is a possibility that the effect of the structure disclosed in this specification can be obtained also by providing, instead of the layer containing calcium and aluminum, an oxide material that achieves a density lower than that of the primary particle and preferably higher than or equal to 2.0 g/cm³ and lower than 3.3 g/cm³ between two adjacent primary particles. Thus, the structure described below is also effective without limitation to the structure using calcium or aluminum.

Another structure disclosed in this specification is a secondary battery including a positive electrode, a negative electrode, and an electrolyte. The positive electrode includes a positive electrode active material containing nickel, cobalt, and manganese. The positive electrode active material includes a secondary particle. The secondary particle includes a plurality of primary particles. An amorphous layer is present between adjacent two of the plurality of primary particles. The thickness of the amorphous layer is greater than or equal to 1 nm and less than or equal to 10 nm.

In the above structure, the density of the amorphous layer is lower than the density of the primary particle (the density of a crystal part of a polycrystal) and is preferably higher than or equal to 2.0 g/cm³ and lower than 3.3 g/cm³. The density is measured by X-ray reflectivity (XRR), for example.

In the above structure, strontium, barium, or magnesium, which is a Group 2 element like calcium, can be used as an element contained in the amorphous layer instead of calcium. In the above structure, gallium or indium, which is a Group 13 element like aluminum, or aluminum can be used as another element contained in the amorphous layer. In the above structure, silicon can be used as another element contained in the amorphous layer. In the above structure, sulfur can be used as another element contained in the amorphous layer.

### Effect of the Invention

According to one embodiment of the present invention, a positive electrode active material that is less likely to deteriorate can be provided. Alternatively, a novel positive electrode active material can be provided. Alternatively, a highly safe or reliable secondary battery can be provided. Alternatively, a secondary battery that is less likely to deteriorate can be provided. Alternatively, a long-life secondary battery can be provided. Alternatively, a novel secondary battery can be provided.

### BRIEF DESCRIPTION OF THE DRAWINGS

FIG. 1A is a cross-sectional image showing part of a secondary particle of one embodiment of the present invention, FIG. 1B is a schematic view thereof, and FIG. 1C is an enlarged view of part of FIG. 1A.

FIG. 2 is an enlarged cross-sectional view showing one embodiment of the present invention.

FIG. 3A is a nanobeam electron diffraction pattern at a point 1-1 in FIG. 2, FIG. 3B is a nanobeam electron diffraction pattern at a point 1-2 in FIG. 2, and FIG. 3C is a nanobeam electron diffraction pattern at a point 1-3 in FIG. 2.

FIG. 4A shows a cross-sectional STEM (Scanning Transmission Electron Microscope) image corresponding to FIG. 2 and results of EDX line extraction in P1-P2 in FIG. 4A, and FIG. 4B shows a cross-sectional STEM image and results of EDX line extraction in P3-P4 in FIG. 4B.

FIG. 5 is a schematic cross-sectional view of a secondary particle to which adhering substances are attached.

FIG. 6 is a surface SEM image of secondary particles to which adhering substances are attached.

FIG. 7A is a scattered electron image (ZC) of a cross section of the vicinity of a surface of a secondary particle, FIG. 7B is a schematic view thereof, and FIG. 7C is an enlarged view of part of FIG. 7A.

FIG. 8A is a HAADF-STEM (High-angle Annular Dark Field Scanning TEM) image corresponding to FIG. 7A, and FIG. 8B, FIG. 8C, FIG. 8D, FIG. 8E, and FIG. 8F are EDX mapping images of elements.

FIG. 9 is a diagram showing an example of a formation process of a secondary particle.

FIG. 10 is a STEM image of the vicinity of a boundary between primary particles in FIG. 7A.

FIG. 11A and FIG. 11B are graphs showing densities and Ca/Al composition ratios.

FIG. 12A is an exploded perspective view of a coin-type secondary battery, FIG. 12B is a perspective view of the coin-type secondary battery, and FIG. 12C is a cross-sectional perspective view thereof.

FIG. 13A illustrates an example of a cylindrical secondary battery. FIG. 13B illustrates an example of the cylindrical secondary battery. FIG. 13C illustrates an example of a plurality of cylindrical secondary batteries. FIG. 13D illustrates an example of a power storage system including the plurality of cylindrical secondary batteries.

FIG. 14A to FIG. 14C are diagrams illustrating an example of a secondary battery.

FIG. 15A and FIG. 15B are diagrams illustrating examples of the appearance of a secondary battery.

FIG. 16A to FIG. 16C are diagrams illustrating a method for manufacturing a secondary battery.

FIG. 17A is a perspective view of a battery pack of one embodiment of the present invention, FIG. 17B is a block diagram of the battery pack, and FIG. 17C is a block diagram of a vehicle including the battery pack.

FIG. 18A to FIG. 18D are diagrams illustrating examples of transport vehicles. FIG. 18E is a diagram illustrating an example of an artificial satellite.

FIG. 19A is a diagram illustrating an electric bicycle, FIG. 19B is a diagram illustrating a secondary battery of the electric bicycle, and FIG. 19C is a diagram illustrating a scooter.

FIG. 20A and FIG. 20B are external views illustrating a charge station.

FIG. 21A and FIG. 21B are cross-sectional observation images of this example.

FIG. 22 is a cross-sectional observation image of a comparative example.

FIG. 23 is a graph showing charge and discharge cycle performance of a secondary battery at 45° C., and is a graph where the vertical axis represents discharge capacity.

FIG. 24 is an example of a schematic cross-sectional view of a Taylor reactor.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

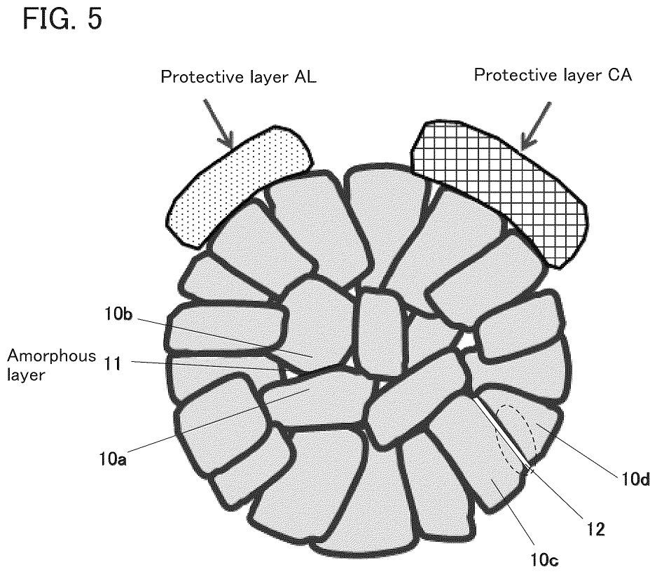

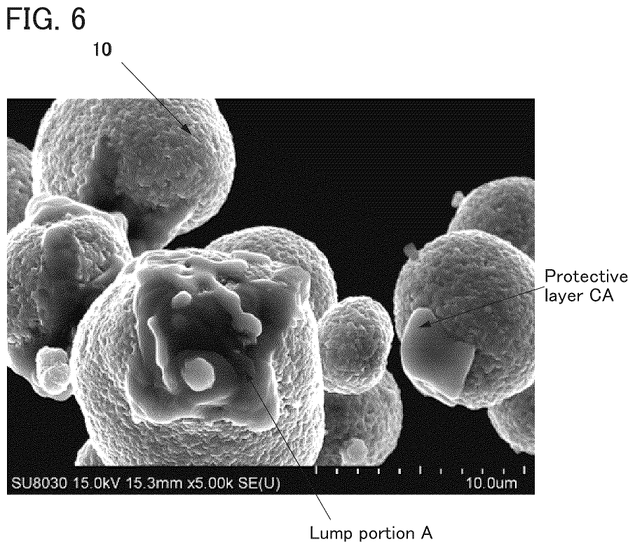

FIG. 5 is a schematic cross-sectional view conceptually illustrating an example of a structure of one secondary particle included in a positive electrode active material. FIG. 5 is a schematic view illustrating a powder particle before being in contact with an electrolyte solution in a secondary battery, that is, before a positive electrode active material layer is formed. In practice, as shown in a SEM image of a secondary particle in FIG. 6, a countless number of primary particles form one spherical secondary particle. Note that in this specification, a spherical shape does not mean a true spherical shape and includes an ellipsoid shape or a distorted spherical shape in a broad sense.

FIG. 5 roughly illustrates four features. The first is the presence of an amorphous layer 11, the second is the presence of an amorphous layer 12, the third is the presence of a protective layer CA, and the fourth is the presence of a protective layer AL. Although the image of the secondary particle in FIG. 6 shows an example where one secondary particle has the first to the third features, the present invention is not particularly limited to this; in a possible variation, one secondary particle has one feature and another secondary particle has another feature, and preferably, any one or more of the features are included in a large number of secondary particles. When at least one secondary particle of the large number of secondary particles has at least the first or the second feature, adhesion between the primary particles is improved.

The present inventors have found that, as illustrated in FIG. 5, in a state where a first primary particle 10a having a first surface and a second primary particle 10b having a second surface are close to each other, a thin layer containing calcium (the amorphous layer 11) and provided between the first surface and the second surface can inhibit cracks in the secondary particle. Provision of the amorphous layer between the primary particles can achieve a positive electrode active material layer where the secondary particle includes a small number of cracks as a whole.

As the primary particle in this embodiment, what is called NCM represented by LiNi_{X}Co_{Y}Mn_{Z}O₂ (X+Y+Z=1) is used. For example, X, Y, and Z preferably satisfy X:Y:Z=1:1:1 or the neighborhood thereof. Alternatively, for example, X, Y, and Z preferably satisfy X:Y:Z=5:2:3 or the neighborhood thereof. Alternatively, for example, X, Y, and Z preferably satisfy X:Y:Z=8:1:1 or the neighborhood thereof. Alternatively, for example, X, Y, and Z preferably satisfy X:Y:Z=9:0.5:0.5 or the neighborhood thereof. Alternatively, for example, X, Y, and Z preferably satisfy X:Y:Z=6:2:2 or the neighborhood thereof. Alternatively, for example, X, Y, and Z preferably satisfy X:Y:Z=1:4:1 or the neighborhood thereof.

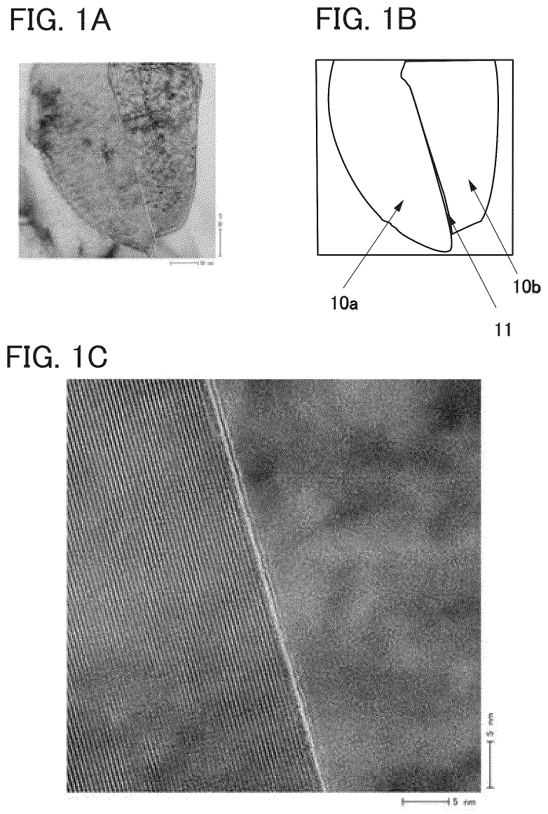

FIG. 1A is a SEM image obtained by observation of part of the inner portion of the secondary particle, which is one of the embodiments, and FIG. 1B is the schematic view thereof. In FIG. 1A, two primary particles in total, the primary particle 10a and the primary particle 10b, can be observed. It is found that there is almost no gap at the boundary between the primary particle 10a and the primary particle 10b. Although there is almost no gap at the boundary between the primary particle 10a and the primary particle 10b, the thin amorphous layer 11 is present there.

FIG. 1C is an enlarged view of a boundary portion between the primary particle 10a and the primary particle 10b. The boundary between the primary particle 10a and the primary particle 10b, which is partly linear, can be clearly observed.

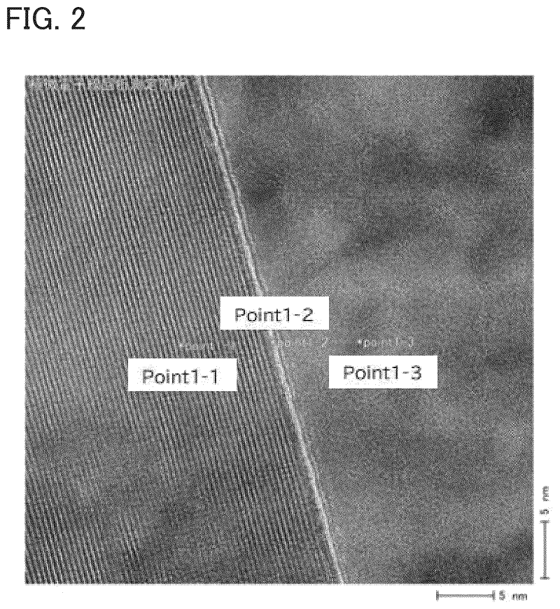

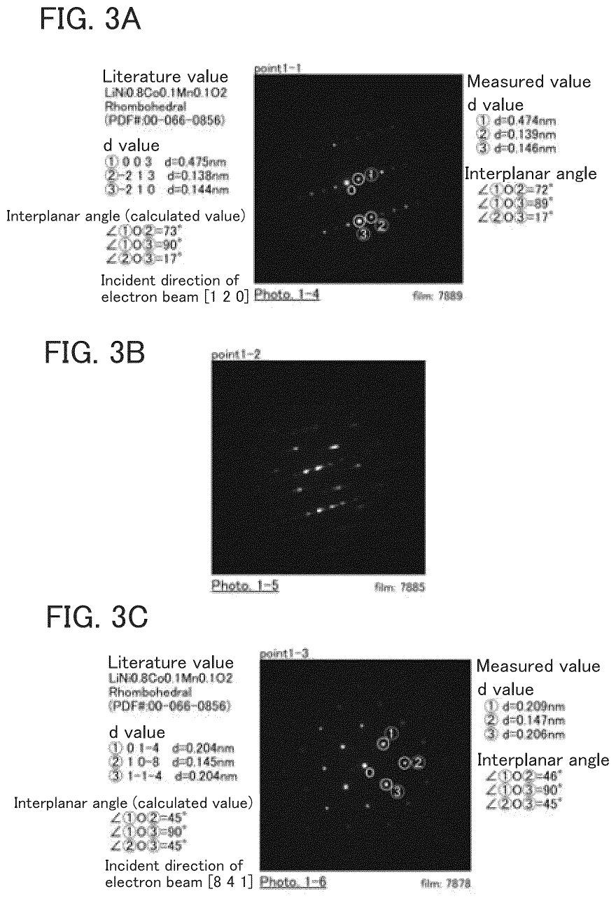

FIG. 2 is an enlarged view of the same portion as FIG. 1C, and FIG. 3 shows the results of analyzing three points by a nanobeam electron diffraction method. At the point 1-1 and the point 1-3, clear spots (diffraction patterns corresponding to a layered rock-salt crystal structure) can be observed, indicating high crystallinity. According to the nanobeam electron diffraction patterns in FIG. 3A and FIG. 3C, the point 1-1 and the point 1-3 each have a layered rock-salt crystal structure. Meanwhile, according to the nanobeam electron diffraction pattern in FIG. 3B, the point 1-2, which is in the vicinity of the boundary between the two primary particles, exhibits an unclear diffraction pattern and is found to be a region with low crystallinity. The region with low crystallinity is also referred to as an amorphous region.

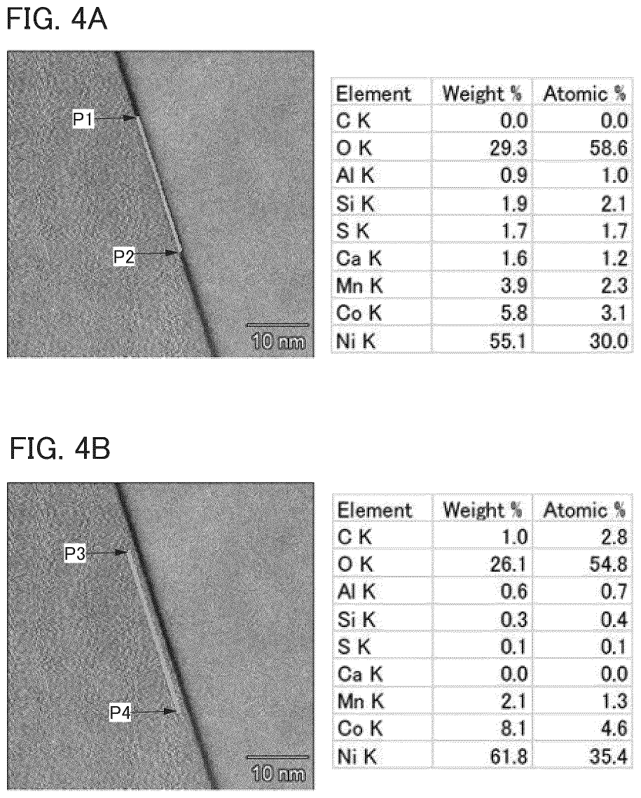

FIG. 4 shows the results of EDX area analysis and EDX linear extraction performed on the same sample using a HAADF-STEM. In FIG. 4A, the vicinity of the boundary, i.e., a linear portion from a point P1 to a point P2 in the amorphous layer, is subjected to the EDX linear extraction, and the results are shown in a table. In the results of the EDX linear extraction in FIG. 4A, aluminum, calcium, sulfur, silicon, and calcium are detected.

In addition, FIG. 4B shows the EDX linear extraction performed on a linear portion from a point P3 to a point P4, which is in a position shifted parallel to the straight line from P1 to P2.

When the results in FIG. 4A and FIG. 4B are compared, calcium is not detected in the results in FIG. 4B; thus, the presence of calcium in the surface portion and the inner portion of the primary particle cannot be confirmed. Furthermore, in the concentration profile, the maximum peak position of aluminum is deviated from those of other elements; the peak is positioned inside the primary particle, and the maximum peak position in the depth direction can be observed in the surface portion of the primary particle. Thus, it can be said that the aluminum concentration is higher in the surface portion of the primary particle than in the amorphous layer. The thin amorphous layer allows diffusion of lithium and hardly hinders the movement of lithium ions transferred in charging and discharging. In the case where the amorphous layer is present between two primary particles positioned along the surface of the secondary particle, the side surface of the amorphous layer is in contact with an electrolyte. Accordingly, lithium is transferred from the electrolyte region to the amorphous layer, and then transferred from the amorphous layer into the primary particle. Thus, electrically, the amorphous layer functions as one of lithium paths.

In addition, physically, the amorphous layer fixes the two primary particles like an adhesive and makes the two primary particles function as a particle group, i.e., a large particle that is not cracked.

When the primary particle having the above features is included at least partly, a positive electrode active material layer in which the secondary particle includes a small number of cracks as a whole can be achieved.

Furthermore, the present inventors have found that the protective layer CA provided outside the secondary particle as illustrated in FIG. 5 also can inhibit cracks in the secondary particle. The provided protective layer CA can fix and protect part of the surface of the secondary particle. In FIG. 6, a state where the protective layer CA is provided outside the secondary particle can be observed. The protective layer CA is lithium carbonate, a composite oxide containing calcium, or a mixture containing lithium carbonate and a composite oxide containing calcium.

When a surface portion 10 of the secondary particle not provided with the protective layer CA was analyzed by surface SEM-EDX (Energy Dispersive X-ray Spectroscopy), calcium was at the lower detection limit.

When a portion where the protective layer CA like an adhering substance on the secondary particle can be observed was analyzed by surface SEM-EDX, calcium was detected, and thus the protective layer CA is presumed to be a lump of calcium oxide. Furthermore, when another portion where the protective layer AL like an adhering substance can be observed was analyzed by EDX, aluminum was detected, and thus the protective layer AL is presumed to be a lump of aluminum oxide.

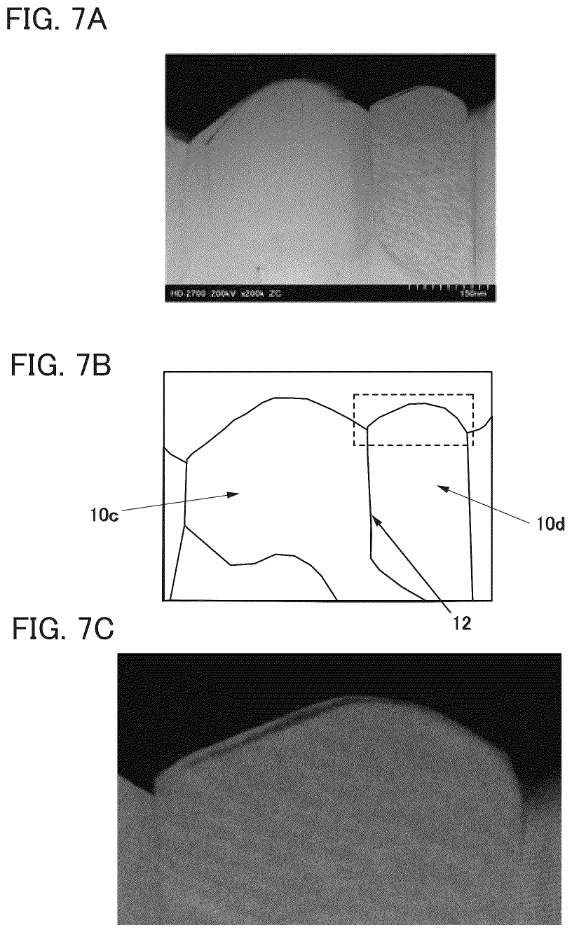

FIG. 7A is a cross-sectional STEM image of part of a surface of a secondary particle, where adjacent primary particles 10c and 10d and the boundary region therebetween can be observed. FIG. 7B is a schematic view of FIG. 7A. Although almost no gap is observed between the adjacent primary particles, the thin amorphous layer 12 is present in the boundary region between the adjacent primary particles, and calcium is detected in a portion of the amorphous layer 12 by EDX. In addition, aluminum is also detected in a portion of the thin amorphous layer 12 by EDX. Furthermore, in the results of EDX, aluminum and calcium are not detected in the center portion of the primary particle 10d, that is, aluminum and calcium are at the lower detection limit.

FIG. 7C is an enlarged image corresponding to a dotted line portion in FIG. 7B, which represents the surface portion of the primary particle 10d that is one of the adjacent primary particles 10c and 10d. In FIG. 7C, aluminum is detected in the surface portion of the primary particle 10d, whereas aluminum in the inner portion is at the lower detection limit. The outermost layer is a nickel oxide layer, a layer containing aluminum (a dark region) is on the inner side of the nickel oxide layer, and NCM is on the inner side of the layer containing aluminum. It is confirmed that the layer containing aluminum (the dark region) is NCM containing aluminum, and aluminum is not detected in the NCM portion on the inner side of the layer containing aluminum.

Note that the portion in FIG. 7B is different from the portion in FIG. 1C, and at least two thin amorphous layers at least exist. Note that the portion in FIG. 7B is a portion close to the outermost surface of the secondary particle, and the portion in FIG. 1C is a portion close to the center of the secondary particle.

Thus, the thin amorphous layer, that is, calcium or aluminum, detected between the primary particles in part of the inner portion of the secondary particle presumably increases the bond strength between the primary particles.

In addition, the thin amorphous layer, that is, calcium or aluminum, detected between the primary particles in part of the surface of the secondary particle also presumably increases the bond strength between the primary particles.

Thus, the thin amorphous layer contributes to an increase in adhesion between the primary particles in both the inner portion of the secondary particle and the surface portion of the secondary particle. The protective layer CA or the protective layer AL, like an adhering substance, is also adhered to the surface of the secondary particle, which can contribute to improving the reliability, that is, inhibiting cracks in the secondary particle or suppressing an increase in the resistance (Li diffusion resistance) in a charge and discharge cycle test.

### Embodiment 2

While Embodiment 1 describes the thin amorphous layer between primary particles, this embodiment describes below a manufacturing method for forming the thin amorphous layer between primary particles. An example of a manufacturing flow for forming the thin amorphous layer between primary particles is shown in a diagram.

### <Step S201: Prepare Raw Material>

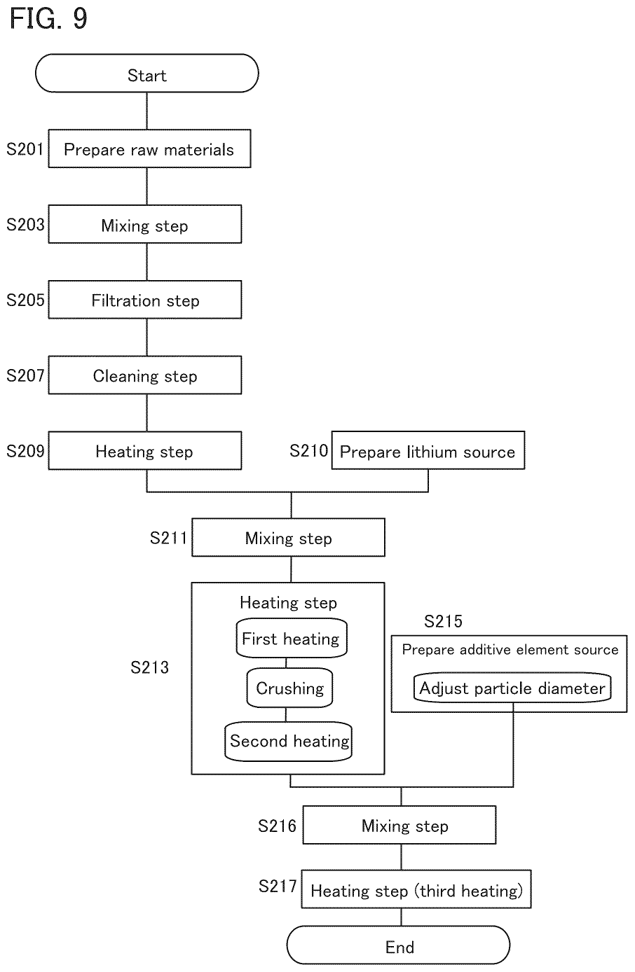

In FIG. 9, first, raw materials corresponding to the kind of the positive electrode active material are prepared. In this manufacturing method 1, an aqueous solution in which at least a transition metal salt is dissolved is prepared. The aqueous solution in which the transition metal salt is dissolved can be referred to as a transition metal source. In the case where the pH value of the aqueous solution in which the transition metal salt is dissolved is smaller than 7, preferably larger than or equal to 1 and smaller than or equal to 6, the aqueous solution exhibits acidity and thus can be referred to as an acidic aqueous solution.

A transition metal is described here. As a transition metal in this embodiment, one or more selected from manganese, cobalt, and nickel can be used. Specifically, as the transition metal, cobalt alone; nickel alone; two elements of cobalt and manganese; two elements of cobalt and nickel; or three elements of cobalt, manganese, and nickel may be used.

In this embodiment, what is called NCM represented by LiNi_{X}Co_{Y}Mn_{Z}O₂ (X+Y+Z=1) is used. A material in which X, Y, and Z satisfy X:Y:Z=8:1:1 or the neighborhood thereof is used. The above values of X, Y, and Z are sometimes referred to as a mixing ratio of nickel, cobalt, and manganese; when the above mixing ratio of X, Y, and Z is satisfied, a layered rock-salt crystal structure can be obtained. The above mixing ratio can be measured by analysis by X-ray photoelectron spectroscopy (XPS), inductively coupled plasma mass spectrometry (ICP-MS), or energy dispersive X-ray spectroscopy (TEM-EDX).

The proportion of nickel in the transition metals is preferably high, in which case a positive electrode active material with high capacity can be formed at low cost. For example, given that the sum of the numbers of nickel, cobalt, and manganese atoms included in the positive electrode active material is 100, the number of nickel atoms is preferably greater than or equal to 33, further preferably greater than or equal to 50, still further preferably greater than or equal to 80. However, when the proportion of nickel is too high, the chemical stability and heat resistance might decrease. For this reason, given that the sum of the numbers of nickel, cobalt, and manganese atoms included in the positive electrode active material is 100, the number of nickel atoms is preferably less than or equal to 95.

Cobalt is preferably contained as the transition metal, in which case the average discharge voltage is high and a secondary battery can be highly reliable because cobalt contributes to stabilization of a layered rock-salt structure. Meanwhile, the price of cobalt is higher and more unstable than those of nickel and manganese; thus, too high a proportion of cobalt might increase the manufacturing cost. For this reason, for example, given that the sum of the numbers of nickel, cobalt, and manganese atoms included in the positive electrode active material is 100, the number of cobalt atoms is preferably greater than or equal to 2.5 and less than or equal to 34.

Manganese is preferably contained as the transition metal, in which case the heat resistance and chemical stability are improved. However, too high a proportion of manganese tends to decrease discharge voltage and discharge capacity. For this reason, for example, given that the sum of the numbers of nickel, cobalt, and manganese atoms included in the positive electrode active material is 100, the number of manganese atoms is preferably greater than or equal to 2.5 and less than or equal to 33.

The aqueous solution in which the transition metal salt is dissolved is described. As the aqueous solution in which the transition metal salt is dissolved, an aqueous solution in which the nickel salt is dissolved or an aqueous solution containing a water-soluble nickel salt can be used, and typically, an aqueous solution in which nickel sulfate, nickel nitrate, or the like is dissolved in water can be used. In such an aqueous solution, nickel ions may exist, and nickel may exist as a complex. In addition, as the aqueous solution in which the transition metal salt is dissolved in the present invention, an aqueous solution in which a cobalt salt is dissolved or an aqueous solution containing a water-soluble cobalt salt can be used, and typically, an aqueous solution in which cobalt sulfate, cobalt nitrate, or the like is dissolved in water can be used. In such an aqueous solution, cobalt ions may exist, and cobalt may exist as a complex. In addition, as the aqueous solution in which the transition metal salt is dissolved, an aqueous solution in which a manganese salt is dissolved or an aqueous solution containing a water-soluble manganese salt can be used, and an aqueous solution in which manganese sulfate, manganese nitrate, or the like is dissolved in water can be used. In such an aqueous solution, manganese ions may exist, and manganese may exist as a complex.

The aqueous solution in which the transition metal salt is dissolved preferably has high purity, and pure water is preferably used for the aqueous solution. The concentration of transition metal ions in the aqueous solution in which the transition metal salt is dissolved is higher than or equal to 1 mol/L and lower than or equal to 5 mol/L, preferably higher than or equal to 2 mol/L and lower than or equal to 3 mol/L. In the case where the aqueous solution contains a plurality of transition metal salts, the total concentration of the transition metal ions falls within the above range.

In the case where three transition metal elements of cobalt, manganese, and nickel are used as the transition metal in the present invention, an aqueous solution in which a cobalt salt, a manganese salt, and a nickel salt are dissolved can be used as the aqueous solution in which the transition metal salt is dissolved. Typically, an aqueous solution in which nickel sulfate, cobalt sulfate, and manganese sulfate are dissolved can be used as the aqueous solution in which the transition metal salt is dissolved.

In order to add sulfur to the amorphous layer to be formed later, a sulfide may be used. In order to add silicon to the amorphous layer to be formed later, a material containing a slight amount of silicon may be used as the raw material.

Furthermore, an aqueous solution exhibiting alkalinity (referred to as an alkaline aqueous solution) is prepared. The alkaline aqueous solution refers to an aqueous solution whose pH value is larger than 7, preferably larger than or equal to 8. As the alkaline aqueous solution in the present invention, an aqueous solution containing sodium hydroxide, potassium hydroxide, lithium hydroxide, or ammonia can be used. For example, an aqueous solution in which sodium hydroxide, potassium hydroxide, lithium hydroxide, or ammonia is dissolved in water can be used. An aqueous solution in which two or more selected from sodium hydroxide, potassium hydroxide, lithium hydroxide, and ammonia are dissolved in water may be used. Pure water is preferably used as the water. The concentration of an alkali in the alkaline aqueous solution is higher than or equal to 1 mol/L and lower than or equal to 10 mol/L, preferably higher than or equal to 3 mol/L and lower than or equal to 7 mol/L. In the case where the aqueous solution contains a plurality of alkalis, the total concentration of the alkalis falls within the above range.

Pure water used for the aqueous solution in which the transition metal salt is dissolved and the alkaline aqueous solution is preferably water having a resistivity of 1 MΩ·cm or higher, further preferably water having a resistivity of 10 MΩ·cm or higher, still further preferably water having a resistivity of 15 MΩ·cm or higher. Water satisfying the above-described resistivity has high purity and contains an extremely small amount of impurities.

### <Step S203: Mixing Step>

Next, the above two aqueous solutions are mixed to manufacture a mixed aqueous solution (referred to as a mixed solution or a coprecipitated mixed solution). In this step, the aqueous solution in which the transition metal salt is dissolved and the alkaline aqueous solution can be reacted with each other. This reaction is referred to as a neutralization reaction, an acid-base reaction, or a coprecipitation reaction in some cases. As the reaction proceeds in this mixing step, a coprecipitated substance is separated out. When the aqueous solution in which the transition metal salt is dissolved and the alkaline aqueous solution are mixed, a hydroxide is formed as the coprecipitated substance. In order to promote the reaction, the temperature of the mixed solution and the pH value of the mixed solution are preferably constant, and further preferably, the mixed solution is stirred. The above temperature is preferably higher than or equal to 40° C. and lower than or equal to 90° C., further preferably higher than or equal to 45° C. and lower than or equal to 70° C. The pH value preferably falls within the range of 9.0 to 13.0, further preferably 10.5 to 11.5. The rotational frequency for the stirring is preferably greater than or equal to 800 rpm and less than or equal to 1200 rpm, further preferably greater than or equal to 900 rpm and less than or equal to 1100 rpm.

In this mixing step, the coprecipitated substance is separated out in the mixed solution as a reaction product. The coprecipitated substance is sometimes precipitated in the mixed solution and is referred to as a precipitate in some cases. When the coprecipitated substance starts to be separated out, the mixed solution sometimes becomes a suspension. Note that the suspension refers to a liquid in which particles of the coprecipitated substance are dispersed.

### <Step S205: Filtration Step>

Next, the above mixed solution is filtered to obtain the coprecipitated substance from the mixed solution. Specifically, the coprecipitated substance is extracted from the mixed solution. Suction filtration is preferably used as the filtration. The coprecipitated substance has a size (major axis) greater than or equal to 1 μm and less than or equal to 20 μm. The coprecipitated substance obtained by filtration may be provided with an ordinal number so as to be distinguished from the coprecipitated substance in the mixed solution, and is sometimes referred to as a filtrated powder.

As the coprecipitated substance, a hydroxide containing the transition metal is obtained. When an aqueous solution containing a nickel salt, a cobalt salt, and a manganese salt is used as the aqueous solution containing the transition metal, a hydroxide containing cobalt, manganese, and nickel (referred to as a composite hydroxide containing cobalt, manganese, and nickel) is obtained as the coprecipitated substance. The coprecipitated substance obtained by filtration, typically the hydroxide, contains impurities such as water.

The hydroxide obtained as the coprecipitated substance may be a secondary particle in which primary particles are aggregated. Note that a primary particle refers to a particle (lump) of the smallest unit found when observed, for example, at a magnification of 20000 times with a SEM (scanning electron microscope) or the like. That is, the primary particle is a particle of the smallest unit. A secondary particle refers to a particle in which the primary particles are aggregated, partially sharing the grain boundary (the circumference and the like of the primary particle), and are not easily separated from each other (a particle independent of the other particles).

### <Step S207: Cleaning Step>

Next, the coprecipitated substance is cleaned to obtain a hydroxide from which impurities are removed. In this cleaning step, cleaning using water can be employed. Cleaning using water is referred to as water cleaning in some cases. Note that the water cleaning can be performed once or repeated a plurality of times. By the water cleaning, impurities and the like can be removed from the coprecipitated substance to some extent. Distilled water or pure water is preferably used as water. In this cleaning step, the water cleaning of the coprecipitated substance may be followed by suction filtration. When the water cleaning is repeated a plurality of times, suction filtration is preferably performed after the water cleaning.

In the above cleaning step, cleaning using an organic solvent can also be employed. Note that cleaning using an organic solvent can be performed once or repeated a plurality of times. By the cleaning using an organic solvent, the coprecipitated substance can be subjected to drying treatment. The drying treatment includes removing water or moisture attached by the prior water cleaning or the like. As the organic solvent, acetone or an alcohol typified by isopropanol (typically, isopropyl alcohol) is preferably used. In this step, the cleaning of the coprecipitated substance using an organic solvent may be followed by suction filtration. When the cleaning using an organic solvent is repeated a plurality of times, suction filtration is preferably performed after the cleaning using the organic solvent.

In the above cleaning step, a combination of water cleaning and cleaning using an organic solvent can also be employed. When suction filtration is employed, a step of water cleaning followed by suction filtration can be performed, and then a step of cleaning using an organic solvent followed by suction filtration can be performed. In that case, the number of times of the water cleaning is preferably larger than the number of times of the cleaning using an organic solvent.

### <Step S209: Heating Step>

A heating step is a step of performing heating on the coprecipitated substance to obtain a precursor where impurities are sufficiently removed. That is, a precursor can be obtained through this heating step.

In this embodiment, in the case where an oxide is generated as the positive electrode active material, a hydroxide before the generation where impurities are sufficiently removed through the heating step of one embodiment of the present invention is referred to as a precursor. The precursor can also be referred to as a nickel compound when having a high proportion of nickel.

Specifically, this heating step can remove hydrogen and oxygen as water from the coprecipitated substance. Removing hydrogen and oxygen as water is referred to as dehydration; thus, this heating step includes a dehydration step. In addition, this heating step can remove water or moisture contained in the coprecipitated substance. Removing water, moisture, or the like is referred to as drying; thus, this heating step includes a drying step. Note that this heating step can also remove impurities as a gas in addition to water, moisture, or the like. For example, the organic solvent used in the cleaning step can also be removed by this heating step.

A supplementary explanation of the temperature of this heating step is provided. The upper limit of the heating temperature in this step is preferably lower than a temperature at which the hydroxide, which is the coprecipitated substance, starts to change to an oxide. That is, this heating step preferably does not cause a change from the hydroxide to an oxide. Note that the temperature at which the hydroxide changes to an oxide can be obtained by thermogravimetry-differential thermal analysis (TG-DTA). When Ni_{0.8}Co_{0.1}Mn_{0.1}(OH)₂ is used as the hydroxide, in a region where a TG curve indicates a reduction in mass, a DTA curve starts to decrease at higher than or equal to 210° C. and lower than or equal to 230° C., typically 220° C. or the vicinity thereof, and the maximum endothermic peak is observed at 260° C. or the vicinity thereof. From this result, the temperature at which the hydroxide starts to be decomposed, dehydrated, or reduced, i.e., the temperature at which the hydroxide starts to change to an oxide can be calculated to be 220° C., and the upper temperature limit of the heat treatment can be set to 220° C.

Note that a higher temperature of the heat treatment is preferable because it promotes the treatment, shortens the duration of the treatment, and enables high productivity.

The lower temperature limit of the heat treatment is higher than or equal to a temperature at which water or moisture of the hydroxide can be removed. Removing water or moisture is also referred to as drying.

In view of the above description, a specific temperature of the heat treatment is preferably higher than or equal to 130° C. and lower than or equal to 220° C., further preferably higher than or equal to 150° C. and lower than or equal to 220° C., still further preferably higher than or equal to 180° C. and lower than or equal to 220° C.

The duration of the heat treatment in this heating step is preferably longer than or equal to 3 hours and shorter than or equal to 15 hours, further preferably longer than or equal to 8 hours and shorter than or equal to 15 hours, still further preferably longer than or equal to 10 hours and shorter than or equal to 13 hours, yet still further preferably longer than or equal to 11 hours and shorter than or equal to 12 hours.

The atmosphere of the heat treatment in this heating step is preferably an atmosphere that does not contain oxygen. The atmosphere that does not contain oxygen is referred to as a non-oxygen atmosphere. As the non-oxygen atmosphere, a dry atmosphere, a vacuum atmosphere, or an inert atmosphere (typically, a nitrogen atmosphere or an argon atmosphere) can be employed. In the case where the heating is performed in a dry atmosphere, the dew point in a container is preferably lower than or equal to −40° C., further preferably lower than or equal to −80° C. In the case where the heating is performed in a vacuum atmosphere, a bell jar type vacuum apparatus including a container (referred to as a bell jar) the inside of which can be evacuated to a vacuum and a vacuum pump connected to the bell jar can be used. In the case where the heating is performed in a vacuum atmosphere, a vacuum drying furnace may be used, and the vacuum drying furnace includes a vacuum pump connected to the drying furnace. As the vacuum pump included in the bell jar type vacuum apparatus or the vacuum drying furnace, a dry pump, a turbomolecular pump, an oil rotary pump, a cryopump, or a mechanical booster pump can be used. The vacuum atmosphere in the bell jar type vacuum apparatus or the vacuum drying furnace includes an atmosphere where the pressure is reduced such that a differential pressure gauge of each apparatus becomes higher than or equal to −0.1 MPa and lower than −0.08 MPa. In the case where the heating is performed in a nitrogen atmosphere, a gas containing nitrogen is supplied into the container of the bell jar type vacuum apparatus or the vacuum drying furnace.

The heat treatment in this heating step may be performed in multiple steps. For example, the heat treatment can be performed at a first temperature for a first duration and then at a second temperature for a second duration. The second temperature falls within the above-described temperature range of the heat treatment. The first temperature is lower than the second temperature and is, for example, a temperature in a range of higher than or equal to 80° C. and lower than 90° C. The second duration falls within the above-described duration range of the heat treatment. The first duration is shorter than the second duration and is, for example, longer than or equal to 0.5 hours and shorter than or equal to 1 hour. The multi-step treatment is preferable because impurities can easily be removed from the precursor.

The manufacturing method of the precursor preferably includes the steps up to this heating step. In other words, the precursor can be obtained through the steps up to this heating step.

In some cases, an amorphous layer is formed between primary particles after this heating step. The amorphous layer in this case is presumed to be an oxide containing silicon or sulfur.

The precursor after this heating step is a powder, which is a secondary particle where a plurality of primary particles are aggregated and whose inner portion includes a gap. Note that the gap in the secondary particle is not present as a hollow structure, and when a liquid is in contact with the powder, the liquid enters the powder from the outside to fill the gap in the secondary particle.

### <Step S210: Prepare Lithium Source>

Subsequently, a lithium source is prepared. The ratio of the lithium source to the precursor (lithium source/precursor) is greater than or equal to 0.90 and less than or equal to 1.05, preferably greater than or equal to 0.92 and less than or equal to 1.01. A lithium compound can be used as the lithium source. Lithium hydroxide, lithium carbonate, or lithium nitrate can be given as the lithium compound. The lithium source preferably has high purity. The lithium source is preferably ground to promote a solid phase reaction. Particle diameter adjustment is preferably performed by grinding before mixing, which is to be performed in a later step, so that the particle size of the lithium source is not too large as compared with the particle size of the precursor.

Lithium hydroxide has a melting point of 462° C., which is low among lithium compounds. In the case of manufacturing a positive electrode active material with a high nickel proportion, heating needs to be performed at a low temperature in order to inhibit cation mixing. Thus, a lithium compound having a low melting point, such as lithium hydroxide, is preferably used for the manufacturing of the positive electrode active material with a high nickel proportion.

### <Step S211: Mixing Step>

Then, the precursor is processed by a solid phase method. Specifically, in Step S211 in FIG. 9, the precursor is mixed with the lithium source to manufacture a mixture. For distinction from the prior mixing step, this mixing step is sometimes provided with an ordinal number. In the present invention, this mixing step is preferably performed by a dry method or a wet method.

A ball mill, a bead mill, a kneader, or the like can be used as a means of the mixing. When a ball mill is used, zirconia balls are preferably used as media, for example.

### <Step S213: Heating Step>

Next, the mixture is heated. For distinction from the prior heating step, this heating step is sometimes provided with an ordinal number.

As heating conditions in this step, heating is preferably performed at a first temperature and then at a second temperature. In some cases, the heating at the first temperature is referred to as first baking, and the heating at the second temperature is referred to as second baking. Note that the second baking may be performed without performing the first baking. That is, this step may be one-step baking.

In this step, the second temperature is preferably higher than the first temperature. In that case, the heating at the first temperature is sometimes referred to as pre-baking, and the heating at the second temperature is sometimes referred to as main baking. Note that main baking may be performed without performing pre-baking. Meanwhile, pre-baking is preferably performed in the case where lithium hydroxide is used as the lithium source.

The first temperature in this step is preferably higher than the melting point of the lithium source. Typically, the first temperature is preferably higher than or equal to 500° C. and lower than or equal to 700° C. The second temperature in this step is preferably higher than 500° C. and lower than or equal to 1050° C., and in the case where the second temperature is higher than the first temperature, the second temperature is preferably higher than 700° C. and lower than or equal to 1050° C.

The durations of the heating at the first temperature and the heating at the second temperature in this step are each preferably longer than or equal to 1 hour and shorter than or equal to 20 hours. The duration of the heating at the first temperature may be equal to, longer than, or shorter than the duration of the heating at the second temperature.

The heating at the first temperature and the heating at the second temperature are each preferably performed in an oxygen atmosphere, and are each particularly preferably performed while oxygen is supplied. Oxygen is preferably supplied at, for example, greater than or equal to 2 L/min and less than or equal to 15 L/min, further preferably greater than or equal to 5 L/min and less than or equal to 10 L/min per liter of furnace inner capacity. The heating atmosphere at the first temperature may be the same as or different from the heating atmosphere at the second temperature.

As a baking apparatus used for the heating at the first temperature and the second temperature, an electric furnace or a rotary kiln furnace can be used. The baking apparatus used for the heating at the first temperature may be the same as or different from the baking apparatus used for the heating at the second temperature.

At the time of the heating, the mixture is preferably put in a crucible or a saggar. In this embodiment, a crucible made of aluminum oxide with a purity of 99.9% is used. Furthermore, the heating is preferably performed with the crucible or the saggar covered with a lid, in which case the materials contained in the mixture can be prevented from subliming. The lid may be placed such that the inside of the crucible is shut off from the inner atmosphere of the furnace, or may be placed to be partly open such that the inside of the crucible can be in contact with the inner atmosphere of the furnace.

Grinding or crushing in a mortar is preferably performed between the heating step at the first temperature and the heating step at the second temperature. The adhered state of the mixtures or the aggregated state of the mixtures can be alleviated by the grinding or crushing. Since adhesion of the mixtures during the heating may result in a decrease in the area of contact with oxygen in the atmosphere, grinding or crushing is preferably performed as described above. Furthermore, after the grinding or crushing, classification may be performed using a sieve.

It is suitable to collect the heated materials after the materials are transferred from the crucible to the mortar in order to prevent impurities from entering the materials. The mortar is suitably made of a material which is less likely to release impurities.

In some cases, an amorphous layer is formed between the primary particles after this heating step. The amorphous layer in this case is presumed to be an oxide containing lithium, silicon, or sulfur.

### <Step S215: Prepare Additive Element Source>

Next, an additive element source are prepared. As the additive element source, aluminum hydroxide, aluminum sulfate, aluminum chloride, aluminum nitrate, calcium oxide, calcium carbonate, calcium hydroxide, or calcium sulfate can be used. The additive element source is weighed such that the additive element is greater than or equal to 0.1 atm % and less than or equal to 5 atm % of a composite oxide (e.g., NCM). A plurality of additive elements may be contained. In the case where a plurality of additive elements are contained, the total concentration of the additive elements satisfies greater than or equal to 0.1 atm % and less than or equal to 5 atm % of a composite oxide (e.g., NCM). In this embodiment, two kinds of materials, calcium carbonate and aluminum hydroxide, whose particle diameters are each reduced to be small relative to the size of the secondary particle of NCM, are used.

### <Step S216: Mixing Step>

In S216, the composite oxide and the additive element source are mixed to manufacture a mixture. The mixing in this step is similar to that in Step S211 of the manufacturing method 1.

### <Step S217: Heating Step>

In Step S217 in FIG. 9, the mixture is heated. The heating in this step is similar to that in Step S213 described above. Note that it is confirmed that calcium is detected in neither the inner portion nor the surface portion of the primary particle after the heating step. Thus, calcium is scattered inside the secondary particle, i.e., between the primary particles, but is present in neither the inner portion nor the surface portion of the primary particle. Calcium is present to surround each of the primary particles inside the secondary particle and contributes to a reduction in change amount of the a-axes or the c-axes of a plurality of crystals included in the primary particles. Moreover, the presence of calcium surrounding each of the primary particles inside the secondary particle contributes to inhibition of oxygen release, and the effect of inhibiting oxygen release is great particularly at high temperature or at high charge voltage.

Meanwhile, it is confirmed that aluminum is not detected in the inner portion of the primary particle after the heating step. Thus, aluminum is scattered inside the secondary particle, i.e., between the primary particles, and detected at a higher concentration in the surface portion of the primary particle than in the other regions, but is absent in the inner portion of the primary particle. However, under a condition of high heating temperature or long heating duration, aluminum may be diffused into not only the surface portion but also the inner portion of the primary particle. In this embodiment, the addition amount, heating temperature, or heating duration is adjusted so that the primary particle has a core-shell structure, i.e., a structure where aluminum is contained in the surface portion and aluminum is not contained in the inner portion.

In this manner, the positive electrode active material can be manufactured. The secondary particle has a spherical shape with a D50 greater than or equal to 5 μm and less than or equal to 15 μm. Note that D50 refers to a 50% cumulative secondary particle diameter calculated using a particle size distribution analyzer (SALD-2200 manufactured by Shimadzu Corporation) using a laser diffraction and scattering method. The particle size may be measured by measuring the major diameter of the cross section of the particle obtained by analysis with a SEM, a transmission electron microscope (TEM), or the like, instead of using laser diffraction particle size distribution measurement. Note that an example of a method for measuring D50 with a SEM, TEM, or the like includes a method for measuring 20 or more particles to make a particle size distribution curve, and setting a particle diameter when the accumulation of particles accounts for 50% as D50.

Note that according to the prepared raw materials, NCM (also referred to as a nickel-cobalt-manganese composite oxide) can be obtained as the positive electrode active material by the manufacturing method 1. NCM obtained is preferably used because high discharge capacity can be obtained as a battery performance.

The positive electrode active material manufactured after this heating step is a powder, which is a secondary particle where a plurality of primary particles are aggregated and whose inner portion includes a gap. At a stage where a secondary battery is manufactured, an electrolyte solution enters the gap.

In addition, in some cases, an amorphous layer is formed between the primary particles after this heating step. The amorphous layer formed between the primary particles fixes the primary particles. The amorphous layer in this case is presumed to be an oxide containing calcium, aluminum, lithium, silicon, or sulfur. Accordingly, the amorphous layer has high lithium ion conductivity and has an effect of promoting lithium ion transfer in charging and discharging of a secondary battery. In addition, part of the amorphous layer can serve as a conduction path of lithium ions when being in contact with an electrolyte solution; thus, the reaction resistance of the whole positive electrode active material layer can be reduced and the output characteristics can be improved.

After this heating step, a calcium compound or an aluminum compound is attached or adhered to the surface of the secondary particle to cover part of the surface of the secondary particle and functions as a protective layer or a barrier layer. Note that in the case where the calcium compound or the aluminum compound is formed on the entire surface of the secondary particle, lithium ion transfer might be hindered in charging and discharging; thus, the calcium compound is preferably not present on the entire surface of the secondary particle.

### Embodiment 3

This embodiment describes examples of shapes of a secondary battery including a positive electrode active material formed by the formation method described in Embodiment 2.

### [Coin-Type Secondary Battery]

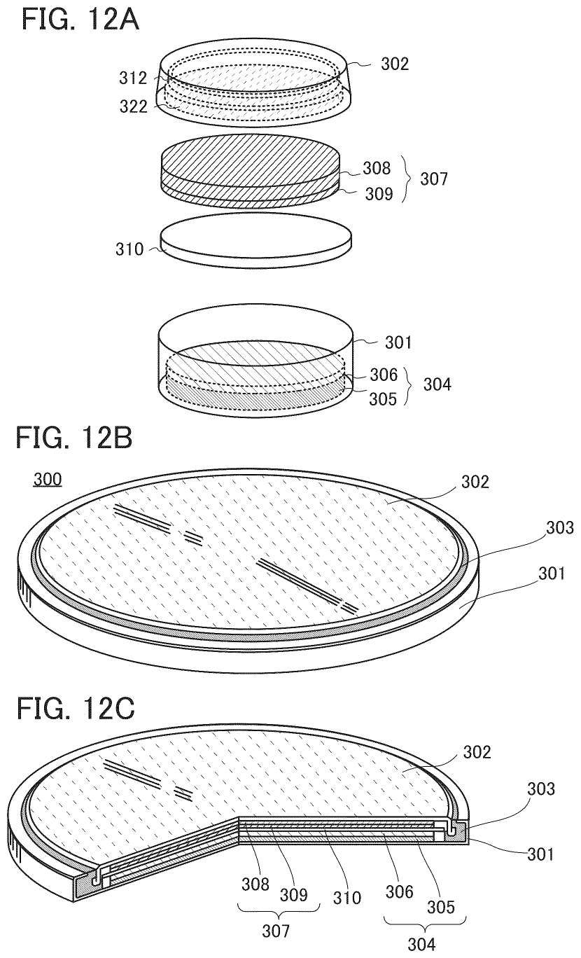

An example of a coin-type secondary battery is described. FIG. 12A is an exploded perspective view of a coin-type (single-layer flat type) secondary battery, FIG. 12B is an external view thereof, and FIG. 12C is a cross-sectional view thereof. Coin-type secondary batteries are mainly used in small electronic devices.

For easy understanding, FIG. 12A is a schematic view illustrating overlap (a vertical relation and a positional relation) between components. Thus, FIG. 12A and FIG. 12B do not completely correspond to each other.

In FIG. 12A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 12A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed on a positive electrode current collector 305.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel or aluminum in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 12C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

With the above-described structure, the coin-type secondary battery 300 can have excellent cycle performance.

### [Cylindrical Secondary Battery]

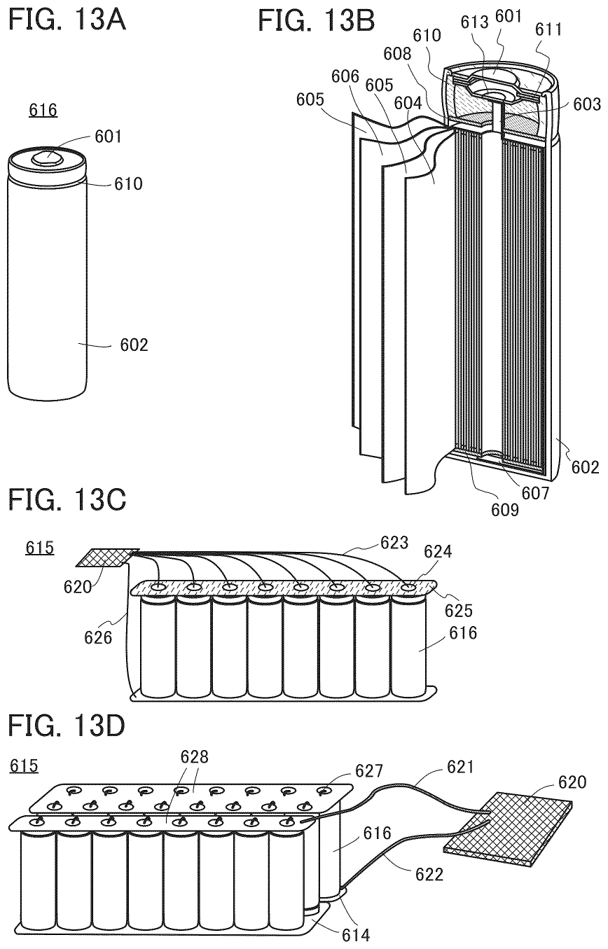

An example of a cylindrical secondary battery is described with reference to FIG. 13A. As illustrated in FIG. 13A, a cylindrical secondary battery 616 includes a positive electrode cap (battery lid) 601 on the top surface and a battery can (outer can) 602 on the side surface and the bottom surface. The positive electrode cap 601 and the battery can (outer can) 602 are insulated from each other by a gasket (insulating gasket) 610.

FIG. 13B is a diagram schematically illustrating a cross section of a cylindrical secondary battery. The cylindrical secondary battery illustrated in FIG. 13B includes the positive electrode cap (battery lid) 601 on the top surface and the battery can (outer can) 602 on the side surface and the bottom surface. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel and aluminum in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material obtained in Embodiment 2 is used for the positive electrode 604, whereby the cylindrical secondary battery 616 can have excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics can be used for the PTC element.

FIG. 13C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit or a protection circuit for preventing overcharging and/or overdischarging can be used.

FIG. 13D illustrates an example of the power storage system 615. The power storage system 615 includes the plurality of secondary batteries 616, and the plurality of secondary batteries 616 are interposed between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### Other Structure Examples of Secondary Battery

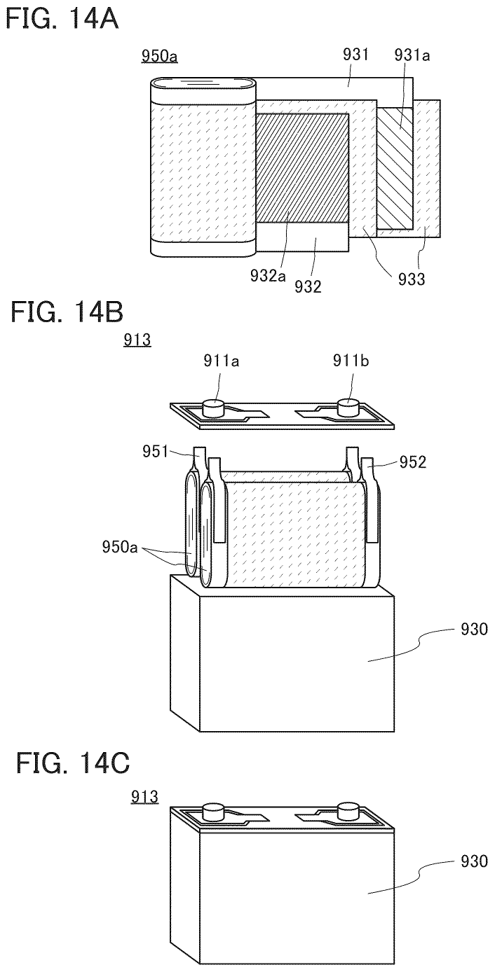

Structure examples of secondary batteries are described with reference to FIG. 14.

As illustrated in FIG. 14A, the secondary battery 913 may include a wound body 950a. The wound body 950a illustrated in FIG. 14A includes a negative electrode 931, a positive electrode 932, and separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931 a is preferably larger than that of the positive electrode active material layer 932a. The wound body 950a having such a shape is preferable because of its high level of safety and high productivity.

The positive electrode active material obtained in Embodiment 2 is used for the positive electrode 932, whereby the secondary battery 913 can have excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931 a is preferably larger than that of the positive electrode active material layer 932a. The wound body 950a having such a shape is preferable because of its high level of safety and high productivity.

As illustrated in FIG. 14B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 14C, the wound body 950a and an electrolyte solution are covered with the housing 930, whereby the secondary battery 913 is completed. The housing 930 is preferably provided with a safety valve, an overcurrent protection element, and the like. For the housing 930, a metal material (e.g., aluminum) or a resin material can be used. In order to prevent the battery from exploding, a safety valve is a valve to be released when the internal pressure of the housing 930 reaches a predetermined pressure.

As illustrated in FIG. 14B, the secondary battery 913 may include a plurality of wound bodies 950a. The use of the plurality of wound bodies 950a enables the secondary battery 913 to have higher discharge capacity.

### <Laminated Secondary Battery>

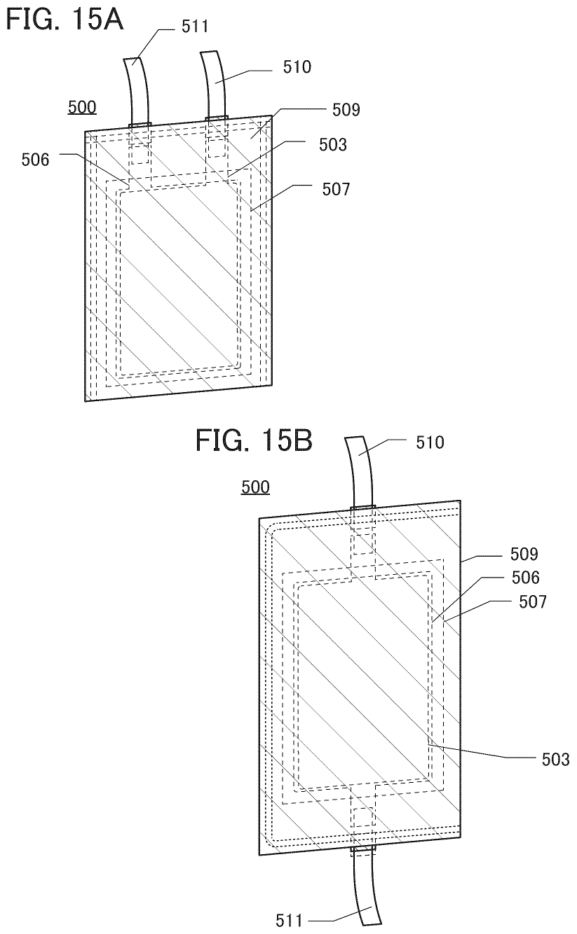

Next, examples of the appearance of a laminated secondary battery are illustrated in FIG. 15A and FIG. 15B. FIG. 15A and FIG. 15B each include a positive electrode 503, a negative electrode 506, a separator 507, an exterior body 509, a positive electrode lead electrode 510, and a negative electrode lead electrode 511.

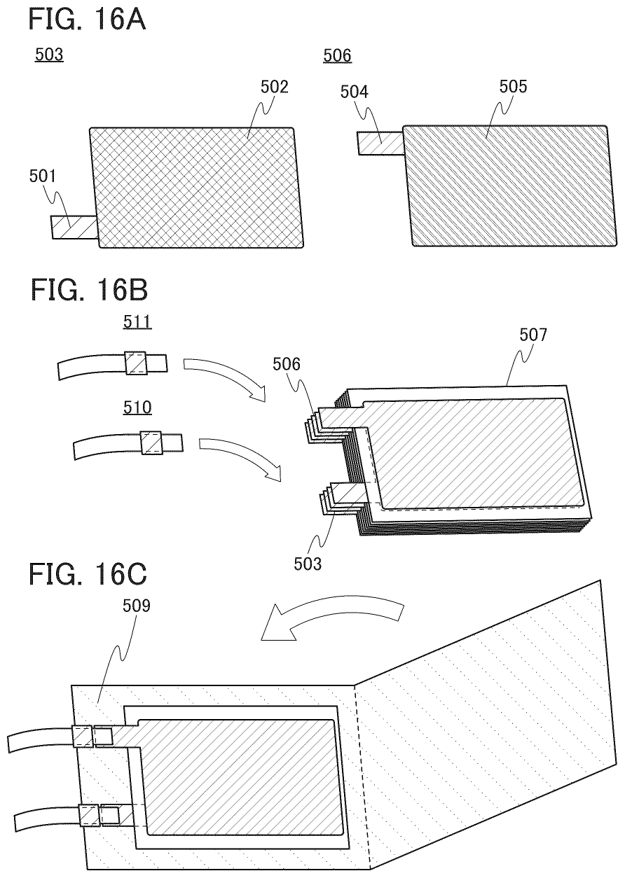

FIG. 16A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples illustrated in FIG. 16A.

### <Manufacturing Method of Laminated Secondary Battery>

An example of a method for manufacturing the laminated secondary battery whose external view is illustrated in FIG. 15A is described with reference to FIG. 16B and FIG. 16C.

First, the negative electrode 506, the separator 507, and the positive electrode 503 are stacked. FIG. 16B illustrates the negative electrodes 506, the separators 507, and the positive electrodes 503 that are stacked. Here, an example in which five negative electrodes and four positive electrodes are used is illustrated. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 16C. Then, the outer edges of the exterior body 509 are bonded to each other.

The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material obtained in Embodiment 2 is used for the positive electrode 503, whereby the secondary battery 500 can have excellent cycle performance.

### Embodiment 4

In this embodiment, examples of vehicles each including the secondary battery of one embodiment of the present invention will be described.

A secondary battery can be used in vehicles, typically automobiles. Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. The vehicle is not limited to an automobile. Examples of vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for the vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 14A or the stacked-layer structure illustrated in FIG. 15A or FIG. 15B.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

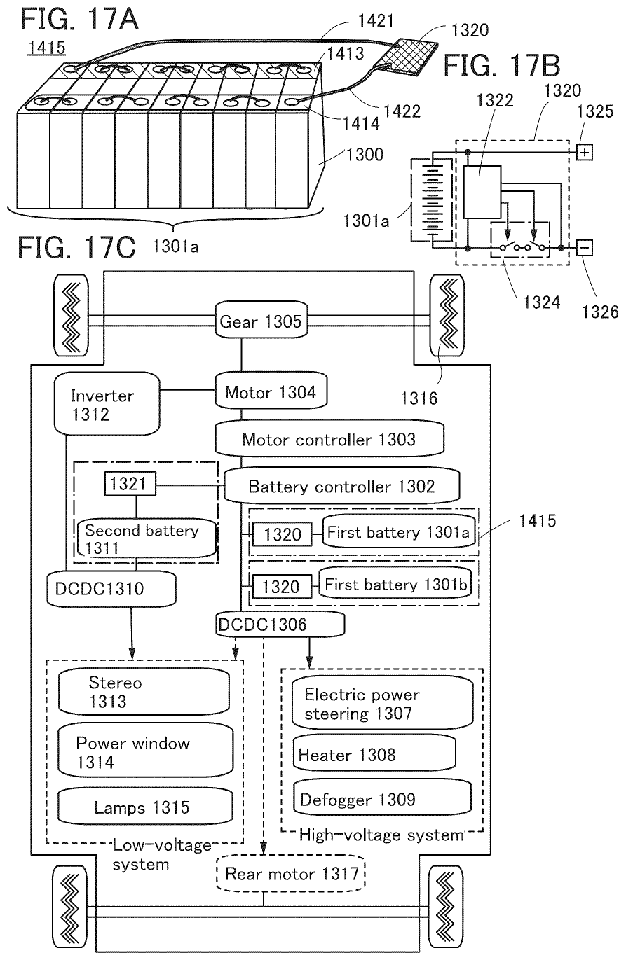

Next, the first battery 1301a is described with reference to FIG. 17A.

FIG. 17A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (a road surface or a motor), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

FIG. 17B illustrates an example of a block diagram of the battery pack 1415 illustrated in FIG. 17A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations have a 100 V outlet, a 200 V outlet, or a three-phase 200V outlet with 50 kW, for example. Furthermore, charging can be performed with electric power supplied from external charge equipment by a contactless power feeding method.

For fast charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the positive electrode active material described in Embodiment 2 is used for the positive electrode, whereby an automotive secondary battery having excellent cycle performance can be provided.

Next, examples in which the secondary battery of one embodiment of the present invention is mounted on a vehicle, typically a transport vehicle, are described.

Mounting the secondary battery illustrated in any of FIG. 12D, FIG. 14C, and FIG. 17A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. Mounting a plurality of the secondary batteries of one embodiment of the present invention can achieve high capacity.

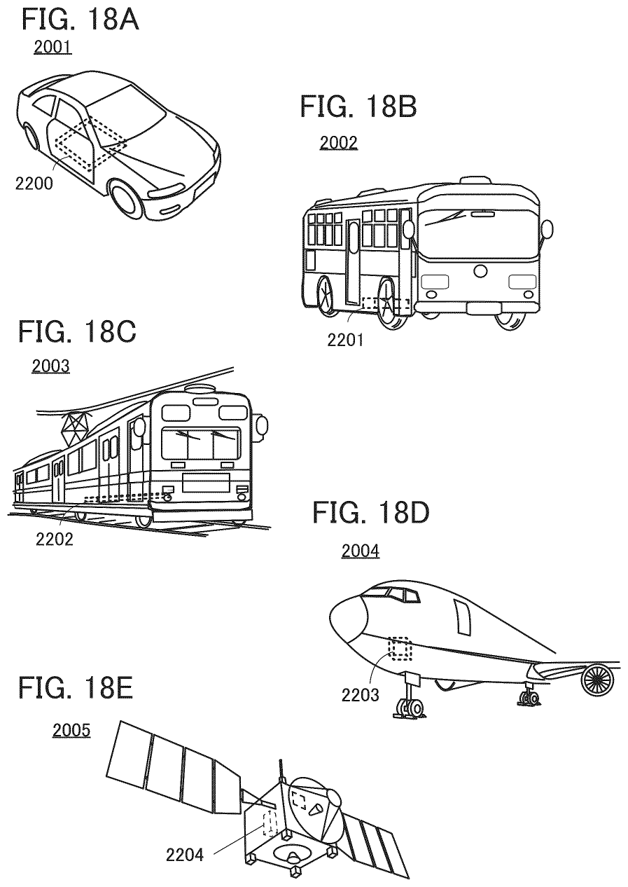

FIG. 18A to FIG. 18D illustrate examples of transport vehicles using one embodiment of the present invention. An automobile 2001 illustrated in FIG. 18A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 3 is provided at one position or several positions. The automobile 2001 illustrated in FIG. 18A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system or a contactless power feeding system. In charging, a given method such as CHAdeMO (registered trademark) or Combined Charging System can be employed as a charge method or the standard of a connector as appropriate. A charge apparatus may be a charge station provided in a commerce facility or a household power supply. For example, with use of the plug-in system, the power storage device mounted on the automobile 2001 can be charged by being supplied with electric power from the outside. Charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 18B illustrates a large transporter 2002 having a motor controlled by electricity as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 18A except for, for example, the number of secondary batteries configuring the secondary battery module; thus, the description is omitted.

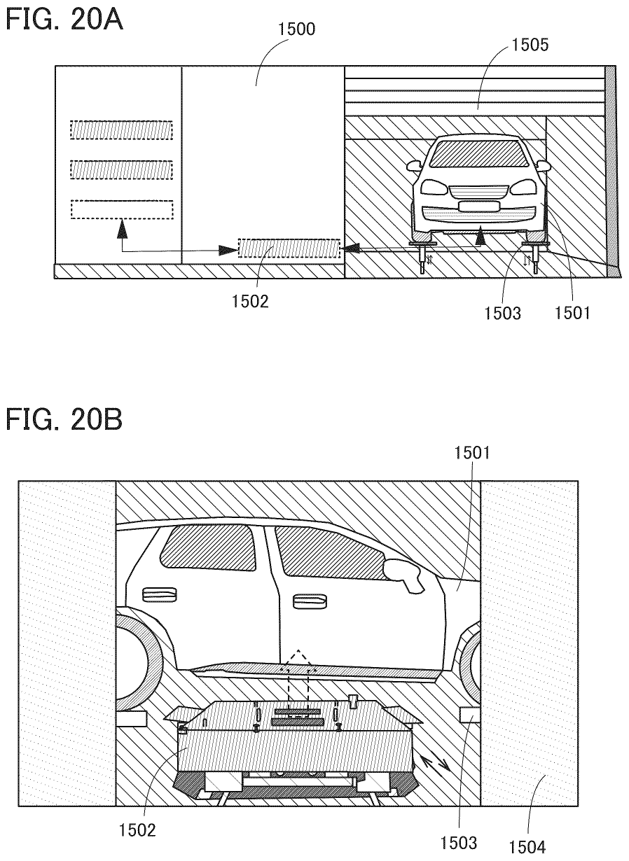

FIG. 18C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material described in Embodiment 2 for the positive electrode, a secondary battery having stable battery characteristics can be manufactured and mass production at low cost is possible in light of the yield. A battery pack 2202 has the same function as that in FIG. 20A except for the number of secondary batteries configuring the secondary battery module; thus, the description is omitted.

FIG. 18D illustrates an aircraft 2004 having a combustion engine as an example. The aircraft 2004 illustrated in FIG. 18D can be regarded as one of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 18A except for the number of secondary batteries configuring the secondary battery module; thus, the description is omitted.

FIG. 18E illustrates an artificial satellite 2005 including a secondary battery 2204 as an example. Because the artificial satellite 2005 is used in an ultra-low-temperature cosmic space, the secondary battery 2204 having excellent low-temperature resistance is preferably provided. It is further preferable that the secondary battery 2204 be mounted inside the artificial satellite 2005 while being covered with a heat-retaining member.

### Embodiment 5

In this embodiment, examples in which the lithium-ion battery using the positive electrode active material of one embodiment of the present invention is mounted on a two-wheeled vehicle and a bicycle will be described as examples of mounting a secondary battery in a vehicle.

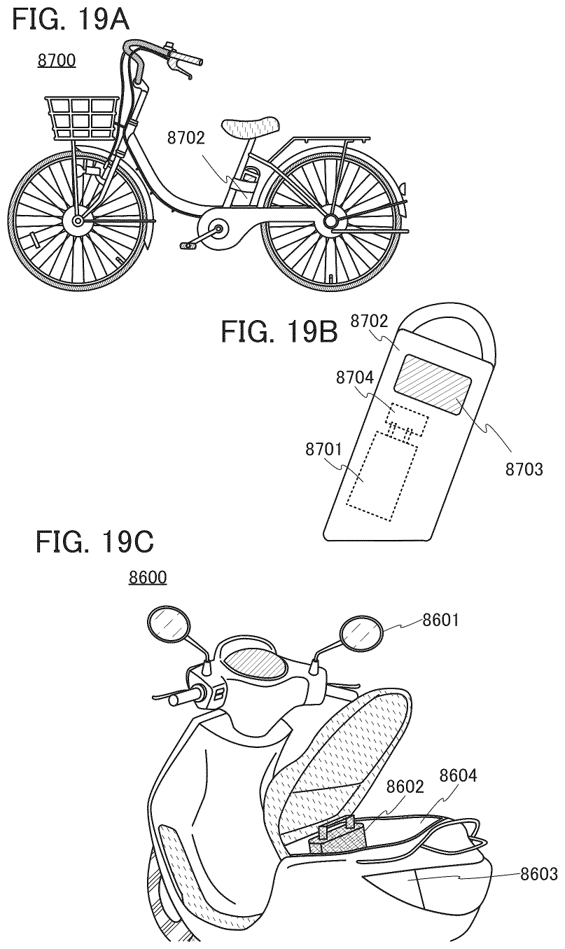

FIG. 19A illustrates an example of an electric bicycle using lithium-ion battery of one embodiment of the present invention. The lithium-ion battery of one embodiment of the present invention can be used for an electric bicycle 8700 illustrated in FIG. 19A. A power storage device includes a plurality of lithium-ion batteries of one embodiment of the present invention and a protection circuit, for example.

The electric bicycle 8700 includes a power storage device 8702. The power storage device 8702 can supply electricity to a motor that assists a rider. The power storage device 8702 is portable, and FIG. 19B illustrates the state where the power storage device 8702 is detached from the bicycle. A plurality of storage batteries 8701 including the positive electrode active material of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery. The control circuit 8704 is electrically connected to a positive electrode and a negative electrode of the storage battery 8701. The secondary battery including a positive electrode using the positive electrode active material obtained in Embodiment 2 and the control circuit 8704 can contribute greatly to elimination of accidents due to secondary batteries, such as fires.

FIG. 19C illustrates an example of a motorcycle using the power storage device of one embodiment of the present invention. A motor scooter 8600 illustrated in FIG. 19C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material obtained in Embodiment 2 can have high capacity and contribute to a reduction in size.

In the motor scooter 8600 illustrated in FIG. 19C, the power storage device 8602 can be stored in an under-seat storage unit 8604. The power storage device 8602 can be stored in the under-seat storage unit 8604 even when the under-seat storage unit 8604 is small.

### Embodiment 6

In this embodiment, an example where the lithium-ion secondary battery of one embodiment of the present invention is mounted on a car will be described with reference to FIG. 20A and FIG. 20B.

FIG. 20A illustrates a schematic view of a station 1500 capable of exchanging secondary batteries. The station 1500 includes a mechanism 1503 for lifting a car, a mechanism for attaching and detaching a secondary battery, a mechanism for charging a secondary battery, and a mechanism for storing secondary batteries.

In addition, the station 1500 includes a shutter 1505, so that the entrance/exit for the car can be opened and closed. The secondary battery exchanging operation might cause electrocution, and thus the shutter 1505 is preferably closed so that the entrance/exit for the car is closed.

After a driver or an operator parks a car 1501 at a predetermined position of the station 1500, the driver or the operator steps out of the car and operates the mechanism 1503 for lifting the car inside the station 1500, so that the car 1501 is lifted. Then, the driver or the operator detaches a secondary battery of the car 1501 using the mechanism for attaching and detaching the secondary battery. The detached secondary battery is moved to be stored in the mechanism for storing secondary batteries, and is charged there. Then, the driver or the operator attaches a new secondary battery that is already charged to the car 1501 using the mechanism for attaching and detaching the secondary battery.

FIG. 20B is a schematic view illustrating a state just before attachment of a new secondary battery 1502 to the car 1501 using the mechanism for attaching and detaching the secondary battery. Note that partition plates 1504 are provided on both sides.

Although FIG. 20A and FIG. 20B illustrate a mechanism for lifting and lowering tires as the mechanism 1503 for lifting the car, there is no particular limitation and a mechanism for lifting and lowering a lower portion of the car body of the car 1501 may be used. Since suspensions are provided between the tires and the car body, in the case where the mechanism for lifting and lowering the tires is used and the tires are pushed from the bottom using the mechanism for attaching and detaching the secondary battery, the car body is also lifted and the secondary battery cannot be attached successfully in some cases. Even with the mechanism for lifting and lowering the lower portion of the car body of the car 1501, in the case where the car body has light weight, the car 1501 loses its balance and the secondary battery cannot be attached successfully in some cases. Accordingly, it is preferable that the alignment of the car 1501 and the secondary battery 1502 or the alignment control of the mechanism for attaching and detaching the secondary battery be precisely performed.

With the station 1500 capable of exchanging secondary batteries illustrated in FIG. 20A and FIG. 20B, long charge time can be omitted by exchange with a new secondary battery, although it takes some time to exchange the secondary batteries. In addition, an old and deteriorating secondary battery can be exchanged with another charged secondary battery anytime. This leads to a longer lifetime of the car 1501 regardless of the deterioration of the secondary battery.

The station 1500 capable of exchanging secondary batteries can be provided at a private residence, a shared space, or a car dealer.

As a system that uses the station 1500 capable of exchanging secondary batteries, a service of exchanging a used secondary battery with another charged secondary battery at the station 1500 installed at a private residence, a shared space, or a car dealer is provided. Such a system can solve the following problem: when the capacity of the secondary battery is significantly reduced by driving, it is difficult to move the car from a charging spot for several hours or half a day for charging the secondary battery. With use of the station 1500, the car can be driven when the secondary battery is exchanged with another secondary battery after driving.

A secondary battery stored in the station 1500 is charged repeatedly, and thus is preferably a secondary battery having excellent cycle performance. In particular, the positive electrode active material obtained in Embodiment 2, which is NCM, is optimal because the coverage of part of the secondary particle with a calcium compound inhibits oxygen release and accordingly enables excellent cycle performance.

This embodiment can be freely combined with the other embodiments.

### Example 1

In this example, in accordance with Embodiment 1, a nickel compound (with a D50 of 9.807 μm) with an element ratio of nickel, cobalt, and manganese of Ni:Co:Mn=8:1:1 is obtained by a coprecipitation method using a synthesis apparatus manufactured by METTLER TOLEDO (Optimax 1001), and then lithium is added thereto.

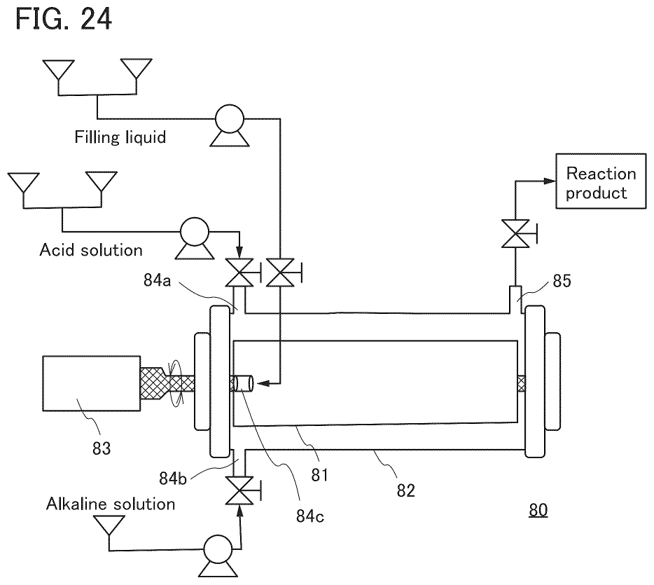

Furthermore, a precursor may be formed utilizing Taylor vortex flow. FIG. 24 shows an example of a schematic cross-sectional view of a Taylor reactor 80. For example, a reactor manufactured by Tipton Corp. (TVF-1 type) can be used. The Taylor reactor 80 includes an outside cylinder 82 and an inside cylinder 81 rotating in the outside cylinder, and Taylor vortex is generated in a gap space formed between the outside cylinder 82 and the inside cylinder 81. The gap space is filled with a fluid, a plurality of kinds of fluids are made to flow into the inside cylinder 81 from inlet holes 84a, 84b, and 84c, and the inside cylinder 81 is rotated with a motor 83, so that the different kinds of fluids are mixed by Taylor vortex flow. Chemical reaction between the different kinds of fluids occurs concurrently with the mixing. In order to make the mixing or the chemical reaction favorable, the temperature is preferably set as appropriate. The obtained reaction product can be taken out from an outlet 85.

An inlet control valve is provided in each supply line connected to the inlet hole for supplying a fluid, and controls the flow of the supplied fluid. In addition, a measuring pump is provided in the supply line connected to the inlet hole for supplying a fluid, and transfers a liquid from a material supply tank.

Furthermore, an outlet control valve for controlling the outlet amount of the reaction product is provided in a supply line for taking out the reaction product, and a pH meter is provided in a line passing through the outlet control valve.

With a Taylor reactor 90, a method for continuously fabricating a mixture by mixing a plurality of fluids at controlled temperature and pressure can be provided, which enables efficiently obtaining uniform reaction products.

In a synthesis example of the precursor, first, a mixed solution of glycine and a sodium hydroxide aqueous solution is supplied as a filling liquid from the inlet hole 84c to fill the gap space in the Taylor reactor 90 with the filling liquid, and then an acid solution and an alkaline solution are supplied from the inlet hole 84a and the inlet hole 84b, respectively. Injection of the acid solution and the alkaline solution is started at the same time, and a precursor is obtained as a reaction product from the outlet 85. Since an initial reaction product is non-uniform, it is preferable that the initial reaction product be disposed and a reaction product be corrected after the state becomes stable.

Specifically, in the case where the Taylor reactor 90 has a volume of approximately 100 mL, the injection rate is controlled to be greater than or equal to 1.4 mL and less than or equal to 2.1 mL by each measuring pump to obtain a reaction product whose pH measured by the pH meter falls within the range of 11.8 to 13, although the injection rate depends on the vessel capacity or the size of the gap (space between the inside cylinder and the outside cylinder). A mixed aqueous solution including an aqueous solution where nickel sulfate, cobalt sulfate, and manganese sulfate each being weighed to obtain 1 M NCM 811 are dissolved and 0.1 M glycine are used as the acid solution, and a mixed aqueous solution including a 2.5 M aqueous solution of sodium hydroxide and 0.1 M glycine is used as the alkaline solution. The temperature is 50° C., the gap between the inside cylinder and the outside cylinder is 2.5 mm, the rotational frequency is 3000 rpm, and the retention time is longer than or equal to 10 minutes and shorter than or equal to 30 minutes.

After the obtained reaction product is centrifuged, suction filtration is performed, whereby particles with a D50 of greater than or equal to 1 μm and less than or equal to 10 μm can be obtained.

Next, as for the addition amount of lithium, LiOH·H₂O was weighed such that the calculated molar ratio of LiOH·H₂O was 0.95 relative to Ni_{0.8}Co_{0.1}Mn_{0.1}(OH)₂ that is regarded as being 1.

After lithium was added and mixed, first heat treatment was performed at 700° C. for 10 hours, the temperature was returned to room temperature and crushing was performed, and then second heat treatment was performed at 800° C. for 10 hours. In the heat treatment, the mixture was put in an alumina crucible covered with a lid and then the alumina crucible was put in a muffle furnace, and oxygen was supplied to the muffle furnace at a flow rate of 5 L/min.

Then, calcium and aluminum were added and third heat treatment was performed at 800° C. for 2 hours. Specifically, the mixture was put in an alumina crucible covered with a lid and then the alumina crucible was put in a muffle furnace, and the heating was performed at 800° C. for two hours. Oxygen was supplied to the muffle furnace at a flow rate of 5 L/min.

Next, as for the addition amount of calcium, CaCO₃ was weighted such that the calculated molar ratio of CaCO₃ was 0.01 relative to Li_{0.95}Ni_{0.8}Co_{0.1}Mn_{0.1} that is regarded as being 1. In this example, calcium carbonate subjected to grinding treatment to have a D50 of 0.762 μm was used.

Note that as for the addition amount of aluminum, Al(OH)₃ was weighed such that the calculated molar ratio of Al(OH)₃ was 0.01 relative to Li_{0.95}Ni_{0.8}Co_{0.1}Mn_{0.1} that is regarded as being 1. In this example, aluminum oxide subjected to grinding treatment to have a D50 of 0.791 μm was used.

After the third heat treatment, the mixture was transferred to a mortar for crushing and made to pass through a sieve, whereby NCM (Li_{0.95}Ni_{0.8}Co_{0.1}Mn_{0.1}O₂) to which calcium and aluminum were added was obtained. The D50 of the NCM was 9.036 μm. To the positive electrode active material of this example, calcium was added in an amount of 1 atomic % and aluminum was added in an amount of 1 atomic %.

FIG. 1A is the SEM image obtained by observing part of the inner portion of the secondary particle of the NCM obtained in this example to which calcium and aluminum were added, and FIG. 1C is the enlarged view of the boundary portion between two primary particles. FIG. 2 is the enlarged view of the same portion as FIG. 1C, and FIG. 3 shows the results of analysis by electron diffraction at the three points.

FIG. 3A shows a selected-area electron diffraction pattern of the point 1-1 in FIG. 2A. Some of bright spots are denoted as 1, 2, 3, and O as shown in FIG. 3A. O denotes transmitted light, and 1, 2, and 3 denote diffraction spots.

The point 1-1 in FIG. 2A is the surface portion of the primary particle and is the inner portion of the primary particle. The measured values of the selected-area diffraction pattern of the inner portion were as follows: d=0.474 nm at 1, d=0.139 nm at 2, and d=0.146 nm at 3. The interplanar angles were ∠1O2=72°, ∠1O3=89°, and ∠2O3=17°.

Note that the literature values of the layered rock-salt NCM 811 when the electron beam incident direction was set to were as follows: d=0.475 nm at 1, d=0.138 nm at 2, and d=0.144 nm at 3. The interplanar angles were ∠1O2=73°, ∠1O3=90°, and ∠2O3=17°. The difference between the measured values and the literature values is considered to be a measurement error.

The point 1-3 in FIG. 2A is the surface portion of the primary particle, which is different from the point 1-1, and is the inner portion of the primary particle. The measured values of the selected-area diffraction pattern of the inner portion were as follows: d=0.209 nm at 1, d=0.147 nm at 2, and d=0.206 nm at 3. The interplanar angles were ∠1O2=46°, ∠1O3=90°, and ∠2O3=45°.

Note that the literature values of the layered rock-salt NCM811 when the electron beam incident direction was set to were as follows: d=0.204 nm at 1, d=0.145 nm at 2, and d=0.204 nm at 3. The interplanar angles were ∠1O2=45°, ∠1O3=90°, and ∠2O3=45°. The difference between the measured values and the literature values is considered to be a measurement error.

These results show that the inner portions of the adjacent primary particles shown in FIG. 1A each have a layered rock-salt crystal structure.

Meanwhile, FIG. 3B, which is the selected-area electron diffraction pattern of the point 1-2, shows that the point 1-2 at least does not have a clear crystal and is amorphous.

Results of EDX spectrum extraction in a measurement region (P1-P2 in FIG. 4A) overlapping with a thin amorphous layer including the point 1-2 are shown below.

TABLE 1

| Element | Weight % | Atomic number concentration % |
|---|---|---|
| C | 0.0 | 0.0 |
| O | 29.3 | 58.6 |
| Al | 0.9 | 1.0 |
| Si | 1.9 | 2.1 |
| S | 1.7 | 1.7 |
| Ca | 1.6 | 1.2 |
| Mn | 3.9 | 2.3 |
| Co | 5.8 | 3.1 |
| Ni | 55.1 | 30.0 |

Results of EDX spectrum extraction in a measurement region (P3-P4 in FIG. 4B) in a position shifted parallel to P1-P2 in FIG. 4A, i.e., in the surface portion of the primary particle, are shown below.

TABLE 2

| Element | Weight % | Atomic number concentration % |
|---|---|---|
| C | 1.0 | 2.8 |
| O | 26.1 | 54.8 |
| Al | 0.6 | 0.7 |
| Si | 0.3 | 0.4 |
| S | 0.1 | 0.1 |
| Ca | 0.0 | 0.0 |
| Mn | 2.1 | 1.3 |
| Co | 8.1 | 4.6 |
| Ni | 61.8 | 35.4 |

FIG. 1 shows observation results of an amorphous layer between the primary particles on the inner side of the outermost surface, i.e., closer to the center portion, as shown in FIG. 5, which is the schematic view of the secondary particle.

FIG. 6 shows a SEM observation image of the NCM obtained in this example to which calcium and aluminum were added.

Results of EDX analysis performed on the protective layer CA portion in FIG. 6 are shown below.

TABLE 3

| Element | Atomic number concentration % |
|---|---|
| O | 56.34 |
| Al | 0.54 |
| Ca | 29.02 |
| Mn | 1.63 |
| Co | 1.46 |
| Ni | 11.01 |
| Total | 100 |

In addition, the results of EDX analysis performed on the surface portion 10 of the secondary particle in FIG. 6 are shown below.

TABLE 4

| Element | Atomic number concentration % |
|---|---|
| O | 67.87 |
| Al | 1.09 |
| Ca | 0.12 |
| Mn | 3.06 |
| Co | 3.21 |
| Ni | 24.65 |
| Total | 100 |

Results of EDX analysis performed on a lump portion around the center of FIG. 6 are shown below.

TABLE 5

| Element | Atomic number concentration % |
|---|---|
| O | 79.08 |
| Al | 0.6 |
| Si | 4.67 |
| S | 0.99 |
| Ca | 11.34 |
| Mn | 0.47 |
| Co | 0.33 |
| Ni | 2.51 |
| Total | 100 |

FIG. 7A shows a ZC image of part of the secondary particle of the NCM obtained in this example to which calcium and aluminum were added. FIG. 7B is a schematic view corresponding to FIG. 7A.

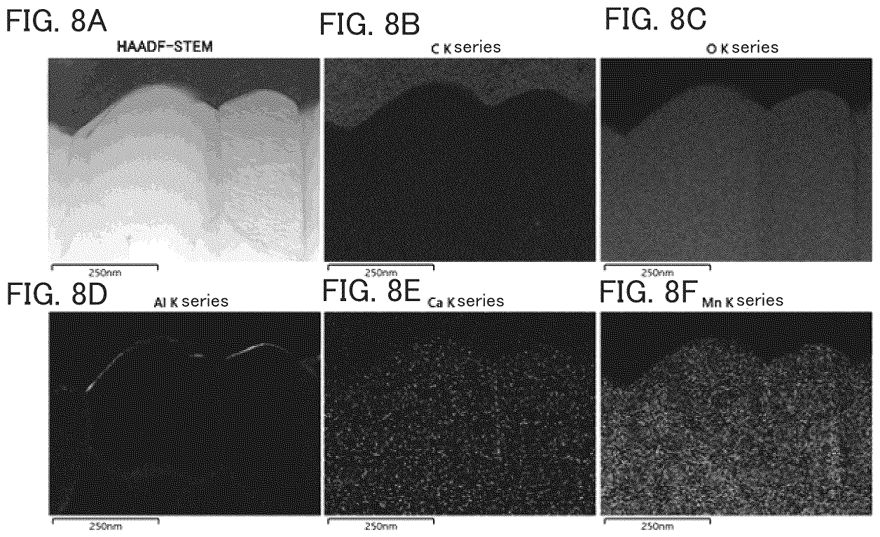

FIG. 8 shows the EDX results of the portion corresponding to FIG. 7A. FIG. 8A is a HAADF-STEM image corresponding to FIG. 7A. FIG. 8B shows an EDX mapping image of carbon (C) in the same region as FIG. 8A, FIG. 8C shows an EDX mapping image of oxygen (O) in the same region as FIG. 8A, FIG. 8D shows an EDX mapping image of aluminum (Al) in the same region as FIG. 8A, FIG. 8E shows an EDX mapping image of calcium (Ca) in the same region as FIG. 8A, and FIG. 8F shows an EDX mapping image of manganese (Mn) in the same region as FIG. 8A. In FIG. 8E, calcium is found to be distributed along the boundary between the primary particle 10a and the primary particle 10b. In FIG. 8D, aluminum is found to be distributed on the outermost surface side of the primary particles 10a and 10b.

Note that the primary particles 10c and 10d, which are in positions different from those of the primary particles 10a and 10b in FIG. 1 as shown in FIG. 5, were observed. The primary particles 10c and 10d are positioned on the outermost surface side of the secondary particle. FIG. 7C is an enlarged view of part of FIG. 7A, and the results of EDX analysis performed on a dark portion that can be observed in the surface portion of the primary particle 10d in FIG. 7C are shown below.

TABLE 6

| Element | Atomic number concentration % |
|---|---|
| C | 22.5 |
| O | 57.3 |
| Al | 9.7 |
| Ca | 0 |
| Mn | 0.4 |
| Co | 1.1 |
| Ni | 9 |
| Total | 100 |

Results of EDX analysis performed on the inner portion of the primary particle 10d are shown below.

TABLE 7

| Element | Atomic number concentration % |
|---|---|
| C | 25.5 |
| O | 56 |
| Al | 0 |
| Ca | 0 |
| Mn | 0.5 |
| Co | 2.2 |
| Ni | 15.8 |
| Total | 100 |

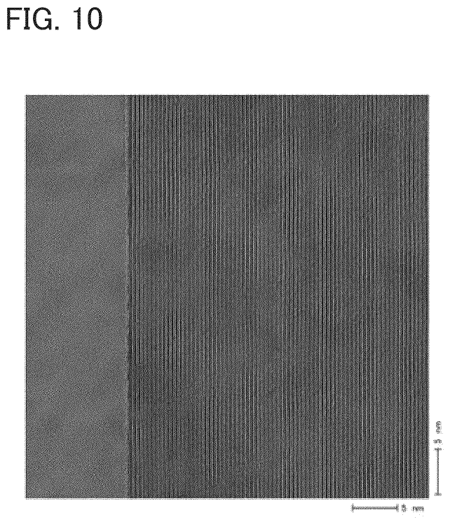

FIG. 10 is an enlarged image of the vicinity of the boundary between the primary particle 10d and the primary particle 10c illustrated in FIG. 7B, and results of EDX analysis performed on the thin amorphous layer 12 present in the vicinity of the boundary are shown below.

TABLE 8

| Element | Atomic number concentration % |
|---|---|
| C | 24 |
| O | 56.7 |
| Al | 0.6 |
| Ca | 0.1 |
| Mn | 0.7 |
| Co | 1.8 |
| Ni | 16.1 |
| Total | 100 |

In the thin amorphous layer 12, silicon and sulfur are each at the lower detection limit. This shows that the secondary particle includes at least two kinds of amorphous layers (the amorphous layer 11 and the amorphous layer 12) that partly differ in the composition. In the amorphous layer 12, silicon and sulfur were each below the lower detection limit, that is, lower than 1 atomic %.

Note that carbon was detected, and the detected carbon is derived from a carbon protective film formed at the time of fabricating a sample with an FIB in order to obtain a cross-sectional STEM image.

The amorphous layer 11 and the amorphous layer 12 each contain calcium or aluminum. Although there is no particular limitation on the compositions of the amorphous layer 11 and the amorphous layer 12, an amorphous oxide obtained by adding an additive element (one or more kinds selected from calcium, aluminum, silicon, and sulfur) is preferably included.

A material used for the protective layer AL or the protective layer CA that is an adhering substance and a material used for the amorphous layer 11 or the amorphous layer 12 are considered below by calculation.

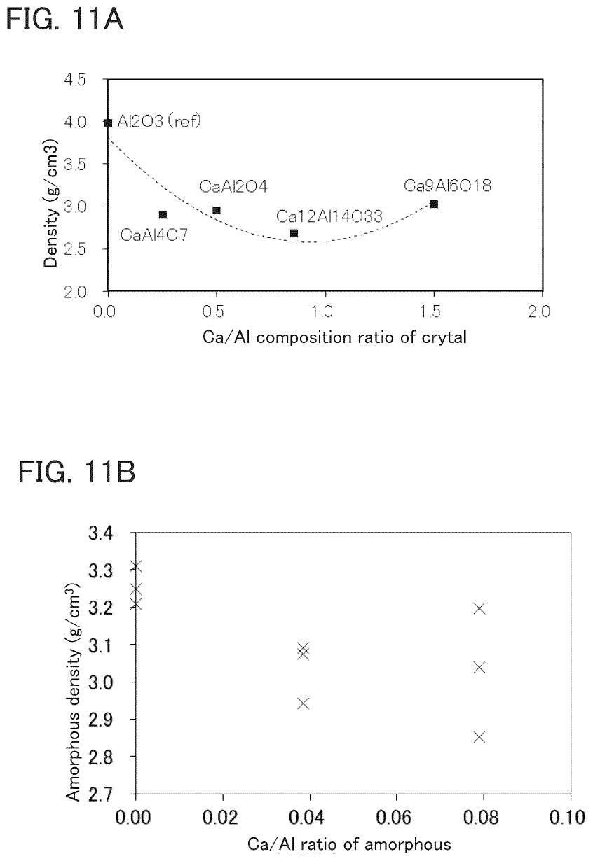

Here, FIG. 11A shows the relation between the density of oxides containing calcium and aluminum and the composition ratio of a crystal. In FIG. 11A, the vertical axis represents density and the horizontal axis represents the Ca/Al ratio in the composition of the crystal. The crystals of CaAl₄O₇, CaAl₂O₄, Ca₁₂Al₁₄O₃₃, and Ca₉Al₆O₁₈ are listed. With the crystal of aluminum oxide as a comparative example, the density is decreased from the density of aluminum oxide (Al₂O₃) of 3.98 g/cm³ when calcium is contained.

This is probably because a gap is easily formed in the crystal due to an ion radius of Ca²⁺ (0.10 nm) that is larger than an ion radius of Al³⁺ (0.039 nm). The numerical values of the five crystals (one of which is the comparative example) are based on the literature values. FIG. 11A shows comparison between the crystals, and the density of the crystal is higher than the density of the amorphous layer.

FIG. 11B shows the results obtained in the following manner: a model was formed using amorphous aluminum oxide, quantum molecular dynamics calculation was performed, and the average value of the densities of the amorphous layer at the time of the calculation excluding the structural relaxation portion at the initial stage of the calculation was obtained.

For the calculation, nine kinds of amorphous initial structures were formed with random atomic arrangement, and molecular dynamics calculation was performed using VASP (Vienna Ab initio Simulation Package) on each of the amorphous structures.

Nine kinds of initial structures in total were used: three kinds of structures each containing 80 Al atoms and 120 oxygen atoms; three kinds of structures each containing 78 Al atoms, 120 oxygen atoms, and 3 Ca atoms; and three kinds of structures each containing 76 Al atoms, 120 oxygen atoms, and 6 Ca atoms. The conditions of the molecular dynamics calculation using VASP are shown below.
VASP: Version 5.4.4
Functional: GGA-PBE
Pseudopotential: PAW
k point: only gamma point
Cut-off energy: 600 eV.
Van der Waals force: DFT-D2
Temperature: 300 K
Timestep: 2.0 fs
Ensemble: NPT

The density was calculated from the average volume in 3000 steps after the structural relaxation of the initial structure was finished.

In FIG. 11B, the horizontal axis represents the Ca/Al ratio in the amorphous and the vertical axis represents the density of the amorphous layer. Note that as the model used for the calculation, three patterns of each of amorphous aluminum oxide (Al₂O₃), amorphous Al₂O₃ to which approximately 4 atomic % Ca with respect to the number of Al atoms was added, and amorphous Al₂O₃ to which approximately 8 atomic % Ca with respect to the number of Al atoms was added were formed with random atomic arrangement.

In FIG. 11B, when the amount of Ca added to the amorphous Al₂O₃ is increased (the Ca/Al ratio is increased), the density tends to decrease. The above results show that adding Ca to the amorphous Al₂O₃ is effective in reducing the density of the amorphous Al₂O₃ (=facilitating Li diffusion).

The amorphous layer 11 and the amorphous layer 12 are preferably formed using a material with a low density, specifically, a material with a density higher than or equal to 2.0 g/cm³ and lower than 3.3 g/cm³. Note that the density of the crystal of calcium oxide (CaO) is 3.34 g/cm³, and the densities of the amorphous layer 11 and the amorphous layer 12 are each preferably lower than that of the crystal of calcium oxide (CaO).

These results indicate the possibility that the material used for the protective layer AL or the protective layer CA, which is an adhering substance, and the material used for the amorphous layer 11 or the amorphous layer 12 each preferably contain at least calcium and aluminum, and that a material with a Ca/Al ratio greater than or equal to 0.25 and less than or equal to 1.5, preferably greater than or equal to 0.5 and less than or equal to 0.85 is advantageous in terms of lithium diffusion. It is probable that when the Ca/Al ratio exceeds 1.5 and the number of atoms per unit volume increases, lithium ions are less likely to be transferred. Although FIG. 11A shows the tendency of the crystals, an amorphous structure probably has the same tendency, that is, lithium ions are less likely to be transferred when the Ca/Al ratio exceeds 1.5 and the number of atoms per unit volume increases.

Without limitation to these materials, another element may be added so as not to increase the density value; for example, silicon oxide or sulfur that is likely to be bonded to lithium may be contained in the material used for the protective layer AL or the protective layer CA, which is an adhering substance, and the material used for the amorphous layer 11 or the amorphous layer 12.

### Example 2

In this example, two kinds of positive electrode active materials were formed in accordance with Example 1, a positive electrode active material layer was formed on a current collector, and cross sectional observation was performed.

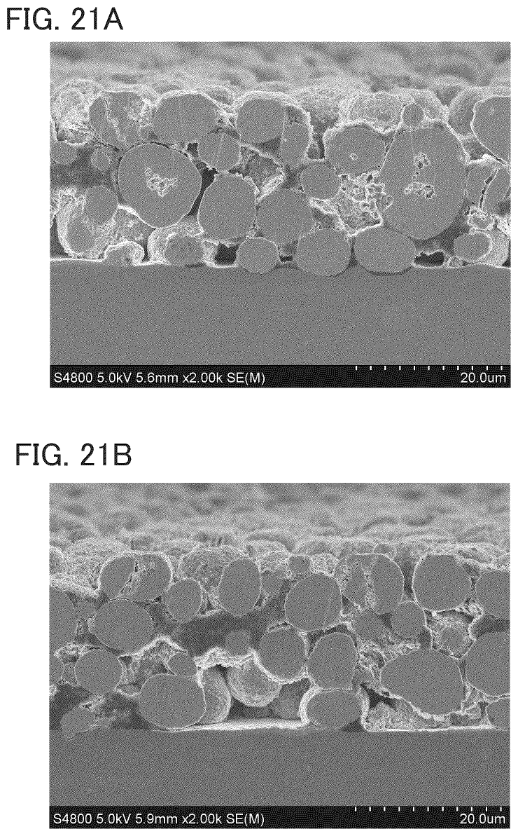

FIG. 21A shows a positive electrode active material layer using NCM which contains 1 atomic % calcium and 1 atomic % aluminum and is the same as that in Example 1. In the sample shown in FIG. 21A, approximately two secondary particles with a crack that is observable in the image are confirmed.

FIG. 21B shows a positive electrode active material layer using NCM containing 1 atomic % calcium. Also in the sample shown in FIG. 21B, approximately two secondary particles with a crack that is observable in the image are confirmed.

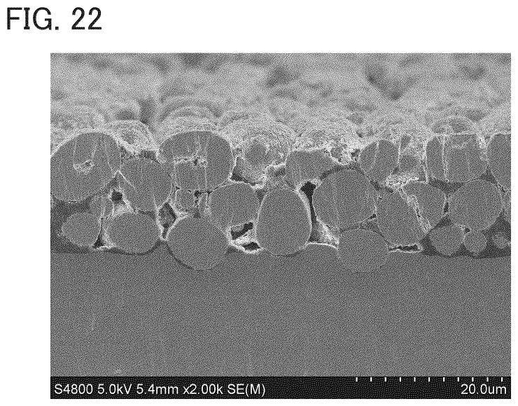

FIG. 22 shows a comparative example, and is a cross-sectional observation image of the sample in which the positive electrode active material layer is formed without addition of aluminum and calcium. In the comparative example, approximately four secondary particles with a crack that is observable in the image are confirmed.

Thus, it can be confirmed that the addition of calcium can inhibit cracks as compared with the comparative example, even at the stage where the positive electrode active material layer is formed on the current collector. Accordingly, the secondary battery using the positive electrode active material layer of this example with a small number of cracks has improved charge and discharge cycle performance.

### Example 3

In this example, half cells were assembled using the positive electrode active material of Example 2 to evaluate the charge and discharge rate characteristics.

The conditions of the half cells are described below. First, the above-described positive electrode active materials were prepared, acetylene black (AB) was prepared as a conductive material, and polyvinylidene fluoride (PVDF) was prepared as a binding agent. Slurry was formed by mixing the positive electrode active material, AB, and PVDF at 95:3:2 (volume ratio), and the slurry was applied on an aluminum current collector. As a solvent of the slurry, NMP was used.

After the slurry was applied on the current collector, the solvent was volatilized. Through the above process, a positive electrode was obtained. In the positive electrode, the loading amount of the active material was approximately 7 mg/cm².

As an electrolyte solution, a solution which is obtained by adding vinylene carbonate (VC) at 2 wt % as an additive to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. As a separator, polypropylene was used.

A lithium metal was prepared as a counter electrode to form coin-type half cells including the above positive electrodes and the like.

### <Cycle Performance>

The cycle performance was measured using the half cells. In the evaluation of cycle performance, the charging voltage was 4.6 V. The measurement temperature was 45° C. CC/CV charging (0.5 C, 0.05 C cut) and CC discharging (0.5 C, 2.5 V cut) were performed, and a 10-minute break was taken before the next charging. In addition, a 10-minute break was also taken after the charging. Note that 1 C was 200 mA/g in this example.

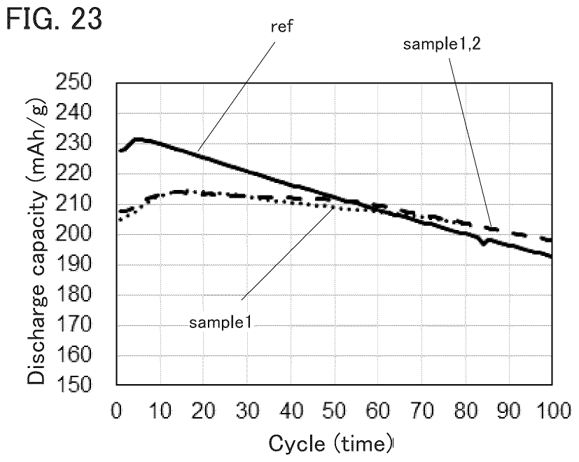

FIG. 23 shows the evaluation results of cycle performance. In FIG. 23, the vertical axis represents discharge capacity. Positive electrode active materials in FIG. 23 are each NCM represented by Li_{0.95}Ni_{X}Co_{Y}Mn_{Z}O₂ (note that X+Y+Z=1, X=0.8, Y=0.1, and Z=0.1), and Sample 1 containing 1 atomic % calcium and 1 atomic % aluminum and a comparative example are shown. The comparative example is a sample obtained by forming a positive electrode active material layer without addition of aluminum and calcium.

As Sample 2, a coin-type half cell formed using a positive electrode active material that contains 0.5 atomic % calcium and 0.5 atomic % aluminum and is NCM represented by Li_{0.95}NiₓCo_{Y}Mn_{Z}O₂ (note that X+Y+Z=1, X=0.8, Y=0.1, and Z=0.1) was used. The fabrication method is the same as that of Sample 1 except for the amounts of calcium and aluminum. Sample 2 exhibits the cycle performance that is substantially the same as and overlaps with that of Sample 1.

The above results confirm that the cycle performance of the positive electrode active material of Example 2 is improved as compared with that of the comparative example by addition of calcium and aluminum between primary particles.

### REFERENCE NUMERALS

10a: primary particle, 10b: primary particle, 10c: primary particle, 10d: primary particle, 11: amorphous layer, 12: amorphous layer, 81: inside cylinder, 82: outside cylinder, 83: motor, 84a: inlet, 84b: inlet, 84c: inlet, 85: outlet, 90: Taylor reactor, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 911a: terminal, 911b: terminal, 913: secondary battery, 930: housing, 931a: negative electrode active material layer, 931: negative electrode, 932a: positive electrode active material layer, 932: positive electrode, 933: separator, 950a: wound body, 951: terminal, 952: terminal, 1300: rectangular secondary battery, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1413: fixing portion, 1414: fixing portion, 1415: battery pack, 1421: wiring, 1422: wiring, 1500: station, 1501: car, 1502: secondary battery, 1503: mechanism, 1504: partition plate, 1505: shutter, 2001: car, 2002: transporter, 2003: transport vehicle, 2004: aircraft, 2005: artificial satellite, 2200: battery pack, 2201: battery pack, 2202: battery pack, 2203: battery pack, 2204: secondary battery, 8600: motor scooter, 8601: side mirror, 8602: power storage device, 8603: indicator light, 8604: under-seat storage, 8700: electric bicycle, 8701: storage battery, 8702: power storage device, 8703: display portion, 8704: control circuit

1. A secondary battery comprising:
a positive electrode, a negative electrode, and an electrolyte,
wherein the positive electrode comprises a positive electrode active material layer comprising nickel, cobalt, and manganese,
wherein the positive electrode active material layer comprises a secondary particle,
wherein the secondary particle comprises a plurality of primary particles,
wherein a layer comprising calcium is included between adjacent two of the plurality of primary particles, and
wherein a thickness of the layer comprising calcium is greater than or equal to 1 nm and less than or equal to 10 nm.

2. The secondary battery according to claim 1, wherein the layer comprising calcium is amorphous.

3. The secondary battery according to claim 1, wherein the layer comprising calcium comprises aluminum.

4. The secondary battery according to claim 1, wherein the layer comprising calcium comprises silicon.

5. The secondary battery according to claim 1, wherein the layer comprising calcium comprises sulfur.

6. The secondary battery according to claim 1, wherein the layer comprising calcium comprises aluminum and has a density being lower than a density of the primary particle and being higher than or equal to 2.0 g/cm³ and lower than 3.3 g/cm³.

7. The secondary battery according to claim 1, wherein a calcium compound is attached to at least part of a surface of the secondary particle.

8. The secondary battery according to claim 1, wherein an aluminum compound is attached to at least part of a surface of the secondary particle.

9. A secondary battery comprising:
a positive electrode, a negative electrode, and an electrolyte,
wherein the positive electrode comprises a positive electrode active material layer comprising nickel, cobalt, and manganese,
wherein the positive electrode active material layer comprises a secondary particle,
wherein the secondary particle comprises a plurality of primary particles,
wherein an amorphous layer is included between adjacent two of the plurality of primary particles, and
wherein a thickness of the amorphous layer is greater than or equal to 1 nm and less than or equal to 10 nm.

10. The secondary battery according to claim 9, wherein a density of the amorphous layer is lower than a density of the primary particle and is higher than or equal to 2.0 g/cm³ and lower than 3.3 g/cm³.

11. The secondary battery according to claim 9, wherein the amorphous layer comprises one or more selected from calcium, strontium, and barium and one or more selected from magnesium, aluminum, gallium, and indium.

12. The secondary battery according to claim 9, wherein the amorphous layer comprises one or more selected from silicon and sulfur.
